(19) United States
(12) Patent Application Publication
(10) Pub. No.: US 2025/0129283 A1
(43) Pub. Date: Apr. 24, 2025

(54) OIL-BASED DRILLING FLUID EMULSIFIERS

(71) Applicant: INGEVITY SOUTH CAROLINA, LLC, North Charleston, SC (US)

(72) Inventors: Aaron S. Engel, North Charleston, SC (US); Shadaab Maghrabi, North Charleston, SC (US); Devin Benjamin Granger, North Charleston, SC (US)

(21) Appl. No.: 18/920,080

(22) Filed: Oct. 18, 2024

Related U.S. Application Data
(60) Provisional application No. 63/672,053, filed on Jul. 16, 2024.
(60) Provisional application No. 63/593,630, filed on Oct. 27, 2023.
(60) Provisional application No. 63/591,336, filed on Oct. 18, 2023.

(51) Int. Cl. C09K 8/32

(52) U.S. Cl. CPC C09K 8/32

(57) ABSTRACT

The present disclosure describes emulsifier composition and methods of making and using the same. The emulsifier composition can include: (a) an emulsifier reaction product made by reacting: a triglyceride composition, a resin acid composition, and a C₃₋₉ carboxylic-acid-bearing dienophile; or (b) an emulsifier blend including a triglyceride reaction product made by reacting a triglyceride composition and a C₃₋₉ carboxylic-acid-bearing dienophile, and a resin acid reaction product made by reacting a resin acid composition and a C₃₋₉ carboxylic-acid-bearing dienophile. The emulsifier composition can include a blend of a fatty acid composition and a reaction product made by reacting: a triglyceride composition and a C₃₋₉ carboxylic-acid-bearing dienophile. The present disclosure further describes a drilling fluid including the emulsifier composition of the present disclosure, as well as methods of making and using the same.

### CROSS-REFERENCE TO RELATED APPLICATIONS

The present application claims priority to, and the benefit of, U.S. Provisional Patent Application No. 63/672,053, filed 16 Jul. 2024, U.S. Provisional Patent Application No. 63/593,630, filed 27 Oct. 2023, and U.S. Provisional Patent Application No. 63/591,336, filed 18 Oct. 2023, each of which is titled OIL-BASED DRILLING FLUID EMULSIFIERS and incorporated by reference herein its entirety for all purposes.

### TECHNICAL FIELD

The present disclosure relates to an emulsifier composition that has superior emulsion stability at high temperature and pressure, while virtually eliminating water filtrate under standard testing conditions. The present disclosure also relates to methods of making the emulsifier composition, drilling fluids comprising the emulsifier composition, and methods of drilling a wellbore.

### BACKGROUND

A drilling fluid (also known as “mud”) is a specially designed fluid that is circulated through an oil or gas wellbore as the wellbore is drilled to facilitate the drilling operation. The drilling fluid can be a water-based drilling fluid (water-based mud) or an oil-based drilling fluid (oil-based mud).

Oil-based drilling fluid or mud is a widely used drilling fluid in the oil and gas production industry. Drilling fluids or muds are used to cool the bit, lubricate the drill string, suspend and transport cuttings, control hydrostatic pressure, and maintain stability. Oil-based drilling fluids or muds, which are also referred to as invert emulsion drilling fluids, are composed of oil as a continuous phase and water as a dispersed phase together with emulsifiers, wetting agents, gellants, etc. The oil phase typically comprises diesel, kerosene, fuel oil, crude oil, or mineral oil. Water-based drilling fluids or muds are composed of water as a continuous phase and oil as a dispersed phase together with, e.g., viscosifiers, fluid loss control agents, weighting agents, lubricants, emulsifiers, corrosion inhibitors, salts, pH control agents, etc.

While materials derived from tall oil (such as fatty acids, rosin, and/or resin acids) are known in the field of emulsifiers for invert emulsion drilling fluids, tall oil-based materials are limited and have become significantly more expensive. Thus, there is a need for emulsifiers that utilize and/or are based on alternative raw materials other than tall oil and current chemistries to increase sustainability.

### SUMMARY

Presently described are emulsifier compositions, as well as methods of making and using the same, and drilling fluids or muds comprising the emulsifier compositions of the present disclosure, as well as methods of making and using the same.

An aspect of the present disclosure provides an emulsifier composition comprising, consisting essentially of, or consisting of, an emulsifier reaction product made by a process comprising, consisting essentially of, or consisting of, reacting: a triglyceride composition (e.g., triglyceride composition present in an amount of about 5.0 wt % to about 80.0 wt % of the reaction mixture); a resin acid composition (e.g., a resin acid composition present in an amount of about 5.0 wt % to about 80.0 wt % of the reaction mixture); and a C₃₋₉ carboxylic-acid-bearing dienophile (e.g., a C₃₋₉ carboxylic-acid-bearing dienophile present in an amount of about 5.0 wt % to about 15.0 wt % of the reaction mixture).

A further aspect of the present disclosure provides a method of making an emulsifier composition of the present disclosure, the method comprising, consisting essentially of, or consisting of, reacting: a triglyceride composition (e.g., a triglyceride composition present in an amount of about 5.0 wt % to about 80.0 wt % of the reaction mixture); a resin acid composition (e.g., a resin acid composition present in an amount of about 5.0 wt % to about 80.0 wt % of the reaction mixture); and a C₃₋₉ carboxylic-acid-bearing dienophile (e.g., a C₃₋₉ carboxylic-acid-bearing dienophile present in an amount of about 5.0 wt % to about 15.0 wt % of the reaction mixture), thereby forming an emulsifier reaction product.

Another aspect of the present disclosure provides an emulsifier composition comprising, consisting essentially of, or consisting of, an emulsifier blend comprising, consisting essentially of, or consisting of: a triglyceride reaction product made by a process comprising, consisting essentially of, or consisting of, reacting a triglyceride composition and a C₃₋₉ carboxylic-acid-bearing dienophile (e.g., the triglyceride composition is present in an amount of about 5.0 wt % to about 80.0 wt % of the reaction mixture, the C₃₋₉ carboxylic-acid-bearing dienophile present in an amount of about 5.0 wt % to about 15.0 wt % of the reaction mixture, or a combination thereof); and a resin acid reaction product made by a process comprising, consisting essentially of, or consisting of, reacting a resin acid composition and a C₃₋₉ carboxylic-acid-bearing dienophile (e.g., the resin acid composition present in an amount of about 5.0 wt % to about 80.0 wt % of the reaction mixture, the C₃₋₉ carboxylic-acid-bearing dienophile present in an amount of about 5.0 wt % to about 15.0 wt % of the reaction mixture, or a combination thereof).

A further aspect of the present disclosure provides a method of making an emulsifier composition of the present disclosure, the method comprising, consisting essentially of, or consisting of, blending: a triglyceride reaction product made by a process comprising, consisting essentially of, or consisting of, reacting a triglyceride composition and a C₃₋₉ carboxylic-acid-bearing dienophile (e.g., the triglyceride composition is present in an amount of about 5.0 wt % to about 80.0 wt % of the mixture, the C₃₋₉ carboxylic-acid-bearing dienophile present in an amount of about 5.0 wt % to about 15.0 wt % of the reaction mixture, or a combination thereof); and a resin acid reaction product made by a process comprising, consisting essentially of, or consisting of, reacting a resin acid composition and a C₃₋₉ carboxylic-acid-bearing dienophile (e.g., the resin acid composition present in an amount of about 5.0 wt % to about 80.0 wt % of the reaction mixture, the C₃₋₉ carboxylic-acid-bearing dienophile present in an amount of about 5.0 wt % to about 15.0 wt % of the reaction mixture, or a combination thereof), thereby forming an emulsifier composition or blend.

In any aspect or embodiment described herein, (i) the triglyceride composition is present in an amount of about 5.0 wt % to about 80.0 wt % (e.g., about 30.0 wt % to about 70.0 wt %) of the reaction mixture; (ii) the resin acid composition present in an amount of about 5 wt % to about 80.0 wt % (about 40.0 wt % to about 80.0 wt %) of the reaction mixture; (iii) the C₃₋₉ carboxylic-acid-bearing dienophile present in an amount of about 5.0 wt % to about 15.0 wt % (about 5.0 wt % to about 7.0 wt %) of the reaction mixture; or (iv) a combination thereof.

In any aspect or embodiment described herein, reacting the triglyceride composition, the resin acid composition, and the C₃₋₉ carboxylic-acid-bearing dienophile, comprises, consists essentially of, or consists of: (i) heating the triglyceride composition, the resin acid composition, and the C₃₋₉ carboxylic-acid-bearing dienophile reaction mixture to about 225° C. to about 245° C. for about 2 hours to about 6 hours (e.g., about 2.5 hours to about 5.5 hours, about 3 hours to about 5 hours, about 3.5 hours to about 4.5 hours, or about 4 hours), optionally sparging the triglyceride composition, the resin acid composition, and the C₃₋₉ carboxylic-acid-bearing dienophile reaction mixture with nitrogen for the last about 0.5 hours to about 2 hours (e.g., about 1 hours), thereby producing the emulsifier reaction product; (ii) heating the triglyceride composition, the resin acid composition, and the C₃₋₉ carboxylic-acid-bearing dienophile reaction mixture to about 225° C. to about 245° C. for about 2 hours to about 4 hours (e.g., about 2.5 hours to about 3.5 hours or about 3 hours), and sparging the triglyceride composition, the resin acid composition, and the C₃₋₉ carboxylic-acid-bearing dienophile reaction mixture with nitrogen at a temperature of about 225° C. to about 245° C. for up to about 3 hours (e.g., up to about 2.5 hours, up to about 2.25 hours, up to about 2 hours, about 0.5 hours to about 2.0 hours, or about 0.5 hours to about 1.5 hours), thereby producing the emulsifier reaction product; (iii) optionally, blending the emulsifier reaction product with a fatty acid composition; (iv) cooling the emulsifier reaction product (e.g., if blending with a fatty acid composition, cooling the reaction product to a temperature of about 60° C. to about 100° C., about 60° C. to about 80° C., or about 70° C.); (v) before blending the fatty acid composition with the emulsifier reaction product, warming the emulsifier reaction product to a temperature of about 100° C. to about 130° C. (e.g., about 110° C. to about 130° C., about 115° C. to about 125° C., or about 120° C.); (vi) before blending the fatty acid composition with the emulsifier reaction product, warming the fatty acid composition to facilitate mixing (e.g., to a temperature of about 70° C. to about 100° C., about 70° C. to about 90° C., about 75° C. to about 85° C., or about 80° C.); or (vii) a combination thereof.

In any aspect or embodiment described herein, (i) the reaction mixture of the triglyceride reaction product comprises, consists essentially of, or consists of, the triglyceride composition in an amount of about 78.0 wt % to about 94.0 wt % (e.g., about 75.0 wt % to about 80.0 wt %), the C₃₋₉ carboxylic-acid-bearing dienophile in an amount of about 6.0 wt % to about 22.0 wt % % (e.g., about 10.0 wt % to about 20.0 wt % or about 18.0 wt % to about 20.0 wt %), or a combination thereof; (ii) the reaction mixture of the resin acid reaction product comprises, consists essentially of, or consists of, the resin acid composition in an amount of about 86.0 wt % to about 92.0 wt % (e.g., about 87.0 wt % to about 90.0 wt %), the C₃₋₉ carboxylic-acid-bearing dienophile in an amount of about 8.0 wt % to about 14.0 wt % (e.g., about 10.0 wt % to about 13.0 wt %), or a combination thereof; (iii) the triglyceride reaction product is present in an amount of about 5.0 wt % to about 50.0 wt % (e.g., about 10.0 wt % to about 30.0 wt % or about 15.0 wt % to about 25.0 wt %) of the emulsifier blend, the resin acid reaction product is present in an amount of about 15.0 wt % to about 65.0 wt % (e.g., about 20.0 wt % to about 50.0 wt % or about 30.0 wt % to about 40.0 wt %) of the emulsifier blend, an additional fatty acid composition is present in an amount of about 10.0 wt % to about 80.0 wt % (e.g., about 40.0 wt % to about 50.0 wt %) of the emulsifier blend, or a combination thereof; or (iv) a combination thereof.

In any aspect or embodiment described herein, the emulsifier blend comprises, consists essentially of, or consists of: (a) the combination of the triglyceride reaction product and the resin acid reaction product are present in an amount of about 50.0 wt % to about 60.0 wt %; (b) a ratio of triglyceride reaction product to resin acid reaction product is about 1:5 to about 3:2; or (c) a combination thereof.

In any aspect or embodiment described herein, (i) reacting a triglyceride composition and a C₃₋₉ carboxylic-acid-bearing dienophile, (ii) reacting a resin acid composition and a C₃₋₉ carboxylic-acid-bearing dienophile, or (iii) both (i) and (ii), comprises, consists essentially of, or consists of: (i) heating the triglyceride composition and C₃₋₉ carboxylic-acid-bearing dienophile reaction mixture to about 225° C. to about 245° C. for about 2 hours to about 6 hours (e.g., about 2.5 hours to about 5.5 hours, about 3 hours to about 5 hours, about 3.5 hours to about 4.5 hours, or about 4 hours), optionally sparging the triglyceride composition and C₃₋₉ carboxylic-acid-bearing dienophile reaction mixture with nitrogen for the last about 0.5 hours to about 2 hours (e.g., about 1 hours), thereby producing the triglyceride reaction product; (ii) heating the triglyceride composition and C₃₋₉ carboxylic-acid-bearing dienophile reaction mixture to about 225° C. to about 245° C. for about 2 hours to about 4 hours (e.g., about 2.5 hours to about 3.5 hours or about 3 hours), and sparging the triglyceride composition and C₃₋₉ carboxylic-acid-bearing dienophile reaction mixture with nitrogen at a temperature of about 225° C. to about 245° C. for up to about 3 hours (e.g., up to about 2.5 hours, up to about 2.25 hours, up to about 2 hours, about 0.5 hours to about 2.0 hours, or about 0.5 hours to about 1.5 hours), optionally sparging is discontinued after the heating process (e.g., at a temperature of about 185° C. to about 200° C. or about 193° C.), thereby producing the triglyceride reaction product; (iii) optionally, blending the triglyceride reaction product and the resin acid reaction product with a fatty acid composition; (iv) cooling the triglyceride reaction product (e.g., if blending with a fatty acid composition, cooling the triglyceride reaction product to a temperature of about 60° C. to about 100° C., about 60° C. to about 80° C., or about 70° C.); (v) heating the resin acid composition and C₃₋₉ carboxylic-acid-bearing dienophile reaction mixture to about 195° C. to about 225° C. for about 0.5 hours to about 3 hours (e.g., about 0.5 hours to about 2.5 hours, about 0.5 hours to about 2.0 hours, or about 0.5 hours to about 1.5 hours), thereby producing the resin acid reaction product; (vi) cooling the resin acid reaction product (e.g., if blending with a fatty acid composition, cooling the resin acid reaction product to a temperature of at least 120° C., about 120° C. to about 160° C., or about 120° C. to about 140° C.); (vii) before blending the fatty acid composition with the triglyceride reaction product and the resin acid reaction product, warming the fatty acid composition to facilitate mixing (e.g., to a temperature of about 70° C. to about 100° C., about 70° C. to about 90° C., about 75° C. to about 85° C., or about 80° C.); or (viii) a combination thereof.

In any aspect or embodiment described herein, the emulsifier composition further comprises, consists essentially of, or consists of, a fatty acid composition.

In any aspect or embodiment described herein, (i) the fatty acid composition includes or is oleic acid, stearic acid, palmitic acid, linoleic, linolenic, a natural fatty acid mixture, crude tall oil (CTO), distilled tall oil, tall oil fatty acids (TOFA, such as Type I TOFA, Type II TOFA, Type III TOFA, or a combination thereof), vegetable oil fatty acid composition, a derivative or modified version thereof, or a mixture thereof; (ii) the fatty acid composition is present in an amount of up to about 70.0 wt % or about 60.0 wt % of the emulsifier composition (e.g., about 20.0 wt % to about 70.0 wt %, about 25.0 wt % to about 65.0 wt % or about 30.0 wt % to about 60.0 wt %); or (iii) a combination thereof.

An additional aspect of the present disclosure provides an emulsifier composition comprising, consisting essentially of, or consisting of, a blend of a fatty acid composition and a reaction product made by a process comprising, consisting essentially of, or consisting of, reacting: a triglyceride composition (e.g., a triglyceride composition present in an amount of about 80.0 wt % to about 95.0 wt % of the reaction mixture); and a C₃₋₉ carboxylic-acid-bearing dienophile (e.g., a C₃₋₉ carboxylic-acid-bearing dienophile present in an amount of about 5.0 wt % to about 20.0 wt % of the reaction mixture).

A further aspect of the present disclosure provides a method of making an emulsifier composition of the present disclosure, the method comprising, consisting essentially of, or consisting of: blending a fatty acid composition and a reaction product made by a process comprising, consisting essentially of, or consisting of, reacting: a triglyceride composition (e.g., a triglyceride composition present in an amount of about 80.0 wt % to about 95.0 wt % of the reaction mixture); and a C₃₋₉ carboxylic-acid-bearing dienophile (e.g., a C₃₋₉ carboxylic-acid-bearing dienophile present in an amount of about 5.0 wt % to about 20.0 wt % of the reaction mixture).

In any aspect or embodiment described herein, the triglyceride composition present in an amount of about 80.0 wt % to about 95.0 wt % of the reaction mixture, the C₃₋₉ carboxylic-acid-bearing dienophile present in an amount of about 5.0 wt % to about 20.0 wt % of the reaction mixture, or a combination thereof.

In any aspect or embodiment described herein, reacting a triglyceride composition and a C₃₋₉ carboxylic-acid-bearing dienophile, comprises, consists essentially of, or consists of: (i) heating the triglyceride composition and C₃₋₉ carboxylic-acid-bearing dienophile reaction mixture to about 225° C. to about 245° C. for about 2 hours to about 6 hours (e.g., about 2.5 hours to about 5.5 hours, about 3 hours to about 5 hours, about 3.5 hours to about 4.5 hours, or about 4 hours), optionally sparging the triglyceride composition and C₃₋₉ carboxylic-acid-bearing dienophile reaction mixture with nitrogen for the last about 0.5 hours to about 2 hours (e.g., about 1 hours), thereby producing the reaction product; (ii) heating the triglyceride composition and C₃₋₉ carboxylic-acid-bearing dienophile reaction mixture to about 225° C. to about 245° C. for about 2 hours to about 4 hours (e.g., about 2.5 hours to about 3.5 hours or about 3 hours), and sparging the triglyceride composition and C₃₋₉ carboxylic-acid-bearing dienophile reaction mixture with nitrogen at a temperature of about 225° C. to about 245° C. for up to about 3 hours (e.g., up to about 2.5 hours, up to about 2.25 hours, up to about 2 hours, about 0.5 hours to about 2.0 hours, or about 0.5 hours to about 1.5 hours), optionally sparging is discontinued after the heating process (e.g., at a temperature of about 185° C. to about 200° C. or about 193° C.), thereby producing the reaction product; (iii) blending the fatty acid composition and the reaction product; (iv) prior to blending the fatty acid composition and the reaction product, cooling the reaction product (e.g., cooling the reaction product to a temperature of about 60° C. to about 100° C., about 60° C. to about 80° C., or about 70° C.); (v) before blending the fatty acid composition and the reaction product, warming the fatty acid composition to facilitate mixing (e.g., to a temperature of about 70° C. to about 100° C., about 70° C. to about 90° C., about 75° C. to about 85° C., or about 80° C.); or (vi) a combination thereof.

In any aspect or embodiment described herein, (i) the fatty acid composition includes or is oleic acid, stearic acid, palmitic acid, linoleic, linolenic, a natural fatty acid mixture, crude tall oil (CTO), distilled tall oil, tall oil fatty acids (TOFA, such as Type I TOFA, Type II TOFA, Type III TOFA, or a combination thereof), vegetable oil fatty acid composition, a derivative or modified version thereof, or a mixture thereof; (ii) the fatty acid composition is present in an amount of up to about 70 wt % or about 60 wt % (e.g., about 20 wt % to about 70 wt %, about 25 wt % to about 65 wt % or about 30 wt % to about 60 wt %) of the emulsifier composition; (iii) the triglyceride composition present in an amount of about 85 wt % to about 95 wt % of the reaction mixture; (iv) the C₃₋₉ carboxylic-acid-bearing dienophile present in an amount of about 5 wt % to about 15 wt % of the reaction mixture; or (v) a combination thereof.

In any aspect or embodiment described herein, (i) the triglyceride composition present in an amount of about 93.0 wt % to about 95.0 wt % of the reaction mixture; (ii) the C₃₋₉ carboxylic-acid-bearing dienophile present in an amount of about 5.0 wt % to about 7.0 wt % of the reaction mixture; or (iii) a combination thereof.

In any aspect or embodiment described herein, (i) the triglyceride composition includes or is a vegetable oil; (ii) the resin acid composition includes or is palustric acid, abietic acid, neoabietic acid, pimaric acid, isopimaric acid, dehydroabietic acid, rosin, tall oil rosin (TOR), gum rosin, wood rosin, or a combination thereof; (iii) the C₃₋₉ carboxylic-acid-bearing dienophile includes or is maleic acid/anhydride, fumaric acid, itaconic acid, or a combination thereof; or (iv) a combination thereof.

In any aspect or embodiment described herein, (i) the vegetable oil of the triglyceride composition includes or is soybean oil, olive oil, corn oil, coconut oil, tallow oil, canola oil, sesame oil, rice bran oil, almond oil, rapeseed oil, safflower oil, grapeseed oil, thistle oil, cottonseed oil, hemp oil, sunflower oil, wheat germ oil, pumpkin seed oil, peanut oil, or a mixture thereof; (ii) the vegetable oil fatty acid composition includes, is, or is derived from, soybean oil, olive oil, corn oil, coconut oil, tallow oil, canola oil, sesame oil, rice bran oil, almond oil, rapeseed oil, safflower oil, grapeseed oil, thistle oil, cottonseed oil, hemp oil, sunflower oil, wheat germ oil, pumpkin seed oil, peanut oil, or a mixture thereof; or (iii) a combination thereof.

Another aspect of the present disclosure provides an oil-based drilling fluid comprising, consisting essentially of, or consisting of, an invert emulsion of a hygroscopic liquid (e.g., a brine, such as CaCl₂ brine), one or more emulsifier, and at least one of: an oil, mineral oil, synthetic oil (e.g., one or more of internal olefin, poly alpha olefin, and linear paraffin), or a combination thereof, wherein the one or more emulsifiers includes the emulsifier composition of the present disclosure, an emulsifier composition produced according to the method of the present disclosure, or a combination thereof.

In any aspect or embodiment described herein, (i) the oil is diesel; (ii) the hygroscopic liquid is CaCl₂ brine, NaCl brine, NaBr brine, CaBr₂ brine, formate brine, potassium formate, an alcohol based hygroscopic liquid, lower polyhydric alcohols, glycerol, or polyglycerol (e.g., CaCl₂ brine); or (iii) a combination thereof.

In any aspect or embodiment described herein, the oil-based drilling fluid further comprising, consisting essentially of, or consisting of: (i) one or more weighting agents (e.g., barite); (ii) one or more rheological modifier (e.g., at least one of: clay, organophilic clay, organoclay, bentonite clay, amine-treated clay, amine-treated bentonite clay, polyamide, dimer diacid, or combinations thereof); (iii) one or more alkalinity agent (e.g., lime, CaO, or Ca(OH)₂); (iv) one or more wetting agent (e.g., fatty imidazolines, soya lecithin, or combinations thereof); or (v) a combination thereof.

In any aspect or embodiment described herein, the oil-based drilling fluid comprises an invert emulsion of a hygroscopic liquid (e.g., a brine, such as CaCl₂ brine), the emulsifier composition, and an oil that includes diesel, mineral oil, and/or internal olefin.

A further aspect of the present disclosure provides a method of drilling a wellbore, the method comprising circulating the oil-based drilling fluid of the present disclosure through the wellbore when drilling (e.g., when drilling the well to depth).

The preceding general areas of utility are given by way of example only and are not intended to be limiting on the scope of the present disclosure and appended claims. Additional objects and advantages associated with the polymers, compositions, methods, and processes of the present disclosure will be appreciated by one of ordinary skill in the art in light of the instant claims, description, and examples. For example, the various aspects and embodiments of the present disclosure can be utilized in numerous combinations, all of which are expressly contemplated by the present disclosure. These additional advantages objects and embodiments are expressly included within the scope of the present disclosure. The publications and other materials used herein to illuminate the background of the invention, and in particular cases, to provide additional details respecting the practice, are incorporated by reference.

### DETAILED DESCRIPTION

The inventors of the present disclosure have surprisingly and unexpectedly discovered that emulsifiers formulations of the present disclosure, comprising one or more modified triglycerides, produced stable emulsions, as demonstrated through fluid loss control under high temperature, high pressure conditions, including using stressed fluid systems at higher temperature (350° F.) than normally tested, as compared to other emulsifiers (e.g., oxidized fatty acids). When the emulsifiers of the present disclosure were examined in oil-based drilling muds/fluids under high temperature and high pressure, fluid loss was less than 10 mL, an important industry standard, while having no water filtrate observed in many of the tested formulations. In fact, no water filtrate was observed and fluid loss was below 10 mL for the exemplary emulsifiers of the present disclosure examined under standard testing conditions (300° F.).

Unless otherwise defined, all technical and scientific terms used herein have the same meaning as commonly understood by one of ordinary skill in the art to which this disclosure belongs. The terminology used in the description is for describing particular embodiments only and is not intended to be limiting of the disclosure.

Where a range of values is provided, it is understood that each intervening value, to the tenth of the unit of the lower limit unless the context clearly dictates otherwise (such as in the case of a group containing a number of carbon atoms in which case each carbon atom number falling within the range is provided), between the upper and lower limit of that range and any other stated or intervening value in that stated range is encompassed within the disclosure. The upper and lower limits of these smaller ranges may independently be included in the smaller ranges is also encompassed within the disclosure, subject to any specifically excluded limit in the stated range. Where the stated range includes one or both of the limits, ranges excluding either/or both of those included limits are also included in the disclosure.

The following terms are used to describe the present disclosure. In instances where a term is not specifically defined herein, that term is given an art-recognized meaning by those of ordinary skill applying that term in context to its use in describing the present disclosure.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, in certain methods described herein that include more than one step or act, the order of the steps or acts of the method is not necessarily limited to the order in which the steps or acts of the method are recited unless the context indicates otherwise.

The term “effective” is used to describe an amount of a compound, composition or component which, when used within the context of its intended use, affects an intended result. The term effective subsumes all other effective amount or effective concentration terms, which are otherwise described or used in the present application.

### Emulsifier Compositions and Methods of Making the Same

As discussed herein, the inventors of the present disclosure surprisingly and unexpected discovered that emulsifier compositions produced with modified triglycerides produces highly stable emulsions with virtually no water filtrate observed, even under stressed (i.e., higher than normally tested) conditions.

### Resin-Acid Based Emulsifier

An aspect of the present disclosure provides an emulsifier composition (e.g., a rosin-acid based emulsifier composition) comprising, consisting essentially of, or consisting of, an emulsifier reaction product made by a process comprising, consisting essentially of, or consisting of, reacting: a triglyceride composition (e.g., a triglyceride composition present in an amount of about 5.0 wt % to about 80.0 wt % of the reaction mixture); a resin acid composition (e.g., a resin acid composition present in an amount of about 5.0 wt % to about 80.0 wt % of the reaction mixture); and a C₃₋₉ carboxylic-acid-bearing dienophile (e.g., a C₃₋₉ carboxylic-acid-bearing dienophile present in an amount of about 5.0 wt % to about 15.0 wt % of the reaction mixture).

A further aspect of the present disclosure provides a method of making an emulsifier composition of the present disclosure, the method comprising, consisting essentially of, or consisting of, reacting: a triglyceride composition (e.g., a triglyceride composition present in an amount of about 5.0 wt % to about 80.0 wt % of the reaction mixture); a resin acid composition (e.g., a resin acid composition present in an amount of about 5.0 wt % to about 80.0 wt % of the reaction mixture); and a C₃₋₉ carboxylic-acid-bearing dienophile (e.g., a C₃₋₉ carboxylic-acid-bearing dienophile present in an amount of about 5.0 wt % to about 15.0 wt % of the reaction mixture, thereby forming an emulsifier reaction product).

Another aspect of the present disclosure provides an emulsifier composition comprising, consisting essentially of, or consisting of, an emulsifier blend comprising, consisting essentially of, or consisting of: a triglyceride reaction product made by a process comprising, consisting essentially of, or consisting of, reacting a triglyceride composition and a C₃₋₉ carboxylic-acid-bearing dienophile (e.g., the triglyceride composition is present in an amount of about 5.0 wt % to about 80.0 wt % of the reaction mixture, the C₃₋₉ carboxylic-acid-bearing dienophile present in an amount of about 5.0 wt % to about 15.0 wt % of the reaction mixture, or a combination thereof); and a resin acid reaction product made by a process comprising, consisting essentially of, or consisting of, reacting a resin acid composition and a C₃₋₉ carboxylic-acid-bearing dienophile (e.g., the resin acid composition present in an amount of about 5.0 wt % to about 80.0 wt % of the reaction mixture, the C₃₋₉ carboxylic-acid-bearing dienophile present in an amount of about 5.0 wt % to about 15.0 wt % of the reaction mixture, or a combination thereof).

A further aspect of the present disclosure provides a method of making an emulsifier composition of the present disclosure, the method comprising, consisting essentially of, or consisting of, blending: a triglyceride reaction product made by a process comprising, consisting essentially of, or consisting of, reacting a triglyceride composition and a C₃₋₉ carboxylic-acid-bearing dienophile (e.g., the triglyceride composition is present in an amount of about 5.0 wt % to about 80.0 wt % of the mixture, the C₃₋₉ carboxylic-acid-bearing dienophile present in an amount of about 5.0 wt % to about 15.0 wt % of the reaction mixture, or a combination thereof); and a resin acid reaction product made by a process comprising, consisting essentially of, or consisting of, reacting a resin acid composition and a C₃₋₉ carboxylic-acid-bearing dienophile (e.g., the resin acid composition present in an amount of about 5.0 wt % to about 80.0 wt % of the reaction mixture, the C₃₋₉ carboxylic-acid-bearing dienophile present in an amount of about 5.0 wt % to about 15.0 wt % of the reaction mixture, or a combination thereof), thereby forming an emulsifier composition or blend.

In any aspect or embodiment described herein, the triglyceride composition is present in an amount of about 5.0 wt % to about 80.0 wt % of the mixture of the emulsifier reaction product, the resin acid composition present in an amount of about 5.0 wt % to about 80.0 wt % of the reaction mixture of the emulsifier reaction product, the C₃₋₉ carboxylic-acid-bearing dienophile present in an amount of about 5.0 wt % to about 15.0 wt % of the reaction mixture of the emulsifier reaction product, or a combination thereof.

In any aspect or embodiment described herein, the triglyceride composition is present in an amount of about 5.0 wt % to about 80.0 wt %, about 5.0 wt % to about 70.0 wt %, about 5.0 wt % to about 60.0 wt %, about 5.0 wt % to about 50.0 wt %, about 5.0 wt % to about 40.0 wt %, about 5.0 wt % to about 30.0 wt %, about 5.0 wt % to about 25.0 wt %, about 15.0 wt % to about 80.0 wt %, about 15.0 wt % to about 70.0 wt %, about 15.0 wt % to about 60.0 wt %, about 15.0 wt % to about 50.0 wt %, about 15.0 wt % to about 40.0 wt %, about 15.0 wt % to about 35.0 wt %, about 25.0 wt % to about 80.0 wt %, about 25.0 wt % to about 70.0 wt %, about 25.0 wt % to about 60.0 wt %, about 25.0 wt % to about 50.0 wt %, about 25.0 wt % to about 45.0 wt %, about 35.0 wt % to about 80.0 wt %, about 35.0 wt % to about 70.0 wt %, about 35.0 wt % to about 60.0 wt %, about 35.0 wt % to about 55.0 wt %, about 45.0 wt % to about 80.0 wt %, about 45.0 wt % to about 70.0 wt %, about 45.0 wt % to about 65.0 wt %, about 55.0 wt % to about 80.0 wt %, about 55.0 wt % to about 75.0 wt %, about 65.0 wt % to about 80.0 wt % of the reaction mixture for the emulsifier reaction product. In any aspect or embodiment described herein, the resin acid composition is present in an amount of about 5.0 wt % to about 80.0 wt %, about 5.0 wt % to about 70.0 wt %, about 5.0 wt % to about 60.0 wt %, about 5.0 wt % to about 50.0 wt %, about 5.0 wt % to about 40.0 wt %, about 5.0 wt % to about 30.0 wt %, about 5.0 wt % to about 25.0 wt %, about 15.0 wt % to about 80.0 wt %, about 15.0 wt % to about 70.0 wt %, about 15.0 wt % to about 60.0 wt %, about 15.0 wt % to about 50.0 wt %, about 15.0 wt % to about 40.0 wt %, about 15.0 wt % to about 35.0 wt %, about 25.0 wt % to about 80.0 wt %, about 25.0 wt % to about 70.0 wt %, about 25.0 wt % to about 60.0 wt %, about 25.0 wt % to about 50.0 wt %, about 25.0 wt % to about 45.0 wt %, about 35.0 wt % to about 80.0 wt %, about 35.0 wt % to about 70.0 wt %, about 35.0 wt % to about 60.0 wt %, about 35.0 wt % to about 55.0 wt %, about 45.0 wt % to about 80.0 wt %, about 45.0 wt % to about 70.0 wt %, about 45.0 wt % to about 65.0 wt %, about 55.0 wt % to about 80.0 wt %, about 55.0 wt % to about 75.0 wt %, about 65.0 wt % to about 80.0 wt % of the reaction mixture for the emulsifier reaction product.

In any aspect or embodiment described herein, the C₃₋₉ carboxylic-acid-bearing dienophile present in an amount of about 5.0 wt % to about 15.0 wt %, about 5.0 wt % to about 14.0 wt %, about 5.0 wt % to about 13.0 wt %, about 5.0 wt % to about 12.0 wt %, about 5.0 wt % to about 11.0 wt %, about 5.0 wt % to about 10.0 wt %, about 5.0 wt % to about 9.0 wt %, about 5.0 wt % to about 8.0 wt %, about 5.0 wt % to about 7.0 wt %, about 5.0 wt % to about 6.0 wt %, about 6.0 wt % to about 15.0 wt %, about 6.0 wt % to about 14.0 wt %, about 6.0 wt % to about 13.0 wt %, about 6.0 wt % to about 12.0 wt %, about 6.0 wt % to about 11.0 wt %, about 6.0 wt % to about 10.0 wt %, about 6.0 wt % to about 9.0 wt %, about 6.0 wt % to about 8.0 wt %, about 6.0 wt % to about 7.0 wt %, about 7.0 wt % to about 15.0 wt %, about 7.0 wt % to about 14.0 wt %, about 7.0 wt % to about 13.0 wt %, about 7.0 wt % to about 12.0 wt %, about 7.0 wt % to about 11.0 wt %, about 7.0 wt % to about 10.0 wt %, about 7.0 wt % to about 9.0 wt %, about 7.0 wt % to about 8.0 wt %, about 8.0 wt % to about 15.0 wt %, about 8.0 wt % to about 14.0 wt %, about 8.0 wt % to about 13.0 wt %, about 8.0 wt % to about 12.0 wt %, about 8.0 wt % to about 11.0 wt %, about 8.0 wt % to about 10.0 wt %, about 8.0 wt % to about 9.0 wt %, about 9.0 wt % to about 15.0 wt %, about 9.0 wt % to about 14.0 wt %, about 9.0 wt % to about 13.0 wt %, about 9.0 wt % to about 12.0 wt %, about 9.0 wt % to about 11.0 wt %, about 9.0 wt % to about 10.0 wt %, about 10.0 wt % to about 15.0 wt %, about 10.0 wt % to about 14.0 wt %, about 10.0 wt % to about 13.0 wt %, about 10.0 wt % to about 12.0 wt %, about 10.0 wt % to about 11.0 wt %, about 11.0 wt % to about 15.0 wt %, about 11.0 wt % to about 14.0 wt %, about 11.0 wt % to about 13.0 wt %, about 11.0 wt % to about 12.0 wt %, about 12.0 wt % to about 15.0 wt %, about 12.0 wt % to about 14.0 wt %, about 12.0 wt % to about 13.0 wt %, about 13.0 wt % to about 15.0 wt %, about 13.0 wt % to about 14.0 wt %, or about 14.0 wt % to about 15.0 wt % of the reaction mixture for the emulsifier reaction product.

In any aspect or embodiment described herein, the reaction mixture of the triglyceride reaction product comprises, consists essentially of, or consists of, the triglyceride composition in an amount of about 78.0 wt % to about 94.0 wt % (e.g., about 75.0 wt % to about 80.0 wt %), the C₃₋₉ carboxylic-acid-bearing dienophile in an amount of about 6.0 wt % to about 22.0 wt % % (e.g., about 10.0 wt % to about 20.0 wt % or about 18.0 wt % to about 20.0 wt %), or a combination thereof. For example, in any aspect or embodiment described herein, the triglyceride composition is present in the reaction mixture of triglyceride reaction product in an amount of about 78.0 wt % to about 94.0 wt %, about 78.0 wt % to about 90.0 wt %, about 78.0 wt % to about 85.0 wt %, about 80.0 wt % to about 94.0 wt %, about 80.0 wt % to about 90.0 wt %, about 80.0 wt % to about 85.0 wt %, about 85.0 wt % to about 94.0 wt %, about 85.0 wt % to about 90.0 wt %, or about 90.0 wt % to about 94.0 wt %. By way of further example, in any aspect or embodiment described herein, the C₃₋₉ carboxylic-acid-bearing dienophile is present in the reaction mixture of the triglyceride reaction product in an amount of about 6.0 wt % to about 22.0 wt %, about 6.0 wt % to about 20.0 wt %, about 6.0 wt % to about 18.0 wt %, about 6.0 wt % to about 16.0 wt %, about 6.0 wt % to about 14.0 wt %, about 6.0 wt % to about 12.0 wt %, about 8.0 wt % to about 22.0 wt %, about 8.0 wt % to about 20.0 wt %, about 8.0 wt % to about 18.0 wt %, about 8.0 wt % to about 16.0 wt %, about 6.0 wt % to about 14.0 wt %, about 10.0 wt % to about 22.0 wt %, about 10.0 wt % to about 20.0 wt %, about 10.0 wt % to about 18.0 wt %, about 10.0 wt % to about 16.0 wt %, about 12.0 wt % to about 22.0 wt %, about 12.0 wt % to about 20.0 wt %, about 12.0 wt % to about 18.0 wt %, about 14.0 wt % to about 22.0 wt %, about 14.0 wt % to about 20.0 wt %, about 16.0 wt % to about 22.0 wt %.

In any aspect or embodiment described herein, the reaction mixture of the resin acid reaction product comprises, consists essentially of, or consists of, the resin acid composition in an amount of about 86.0 wt % to about 92.0 wt % (e.g., about 87.0 wt % to about 90.0 wt %), the C₃₋₉ carboxylic-acid-bearing dienophile in an amount of about 8.0 wt % to about 14.0 wt % (e.g., about 10.0 wt % to about 13.0 wt %), or a combination thereof. For example, in any aspect or embodiment described herein, the resin acid composition is present in the reaction mixture of resin acid reaction product in an amount of about 86.0 wt % to about 92.0 wt %, about 86.0 wt % to about 91.0 wt %, about 86.0 wt % to about 90.0 wt %, about 86.0 wt % to about 89.0 wt %, about 86.0 wt % to about 88.0 wt %, about 86.0 wt % to about 87.0 wt %, about 87.0 wt % to about 92.0 wt %, about 87.0 wt % to about 91.0 wt %, about 87.0 wt % to about 90.0 wt %, about 87.0 wt % to about 89.0 wt %, about 87.0 wt % to about 88.0 wt %, about 89.0 wt % to about 92.0 wt %, about 89.0 wt % to about 91.0 wt %, about 89.0 wt % to about 90.0 wt %, about 90.0 wt % to about 92.0 wt %, about 90.0 wt % to about 91.0 wt %, or about 91.0 wt % to about 92.0 wt %. By way of further example, in any aspect or embodiment described herein, the C₃₋₉ carboxylic-acid-bearing dienophile is present in the reaction mixture of resin acid reaction product in an amount of about 8.0 wt % to about 14.0 wt %, about 8.0 wt % to about 13.0 wt %, about 8.0 wt % to about 12.0 wt %, about 8.0 wt % to about 11.0 wt %, about 8.0 wt % to about 10.0 wt %, about 8.0 wt % to about 9.0 wt %, about 9.0 wt % to about 14.0 wt %, about 9.0 wt % to about 13.0 wt %, about 9.0 wt % to about 12.0 wt %, about 9.0 wt % to about 11.0 wt %, about 9.0 wt % to about 10.0 wt %, about 10.0 wt % to about 14.0 wt %, about 10.0 wt % to about 13.0 wt %, about 10.0 wt % to about 12.0 wt %, about 10.0 wt % to about 11.0 wt %, about 11.0 wt % to about 14.0 wt %, about 11.0 wt % to about 13.0 wt %, about 11.0 wt % to about 12.0 wt %, about 12.0 wt % to about 14.0 wt %, about 12.0 wt % to about 13.0 wt %, about 13.0 wt % to about 14.0 wt %.

In any aspect or embodiment described herein, the triglyceride reaction product is present in an amount of about 5.0 wt % to about 50.0 wt % (e.g., about 10.0 wt % to about 30.0 wt % or about 15.0 wt % to about 25.0 wt %) of the emulsifier blend, the resin acid reaction product is present in an amount of about 15.0 wt % to about 65.0 wt % (e.g., about 20.0 wt % to about 50.0 wt % or about 30.0 wt % to about 40.0 wt %) of the emulsifier blend, an additional fatty acid composition is present in an amount of about 10.0 wt % to about 80.0 wt % (e.g., about 40.0 wt % to about 50.0 wt %) of the emulsifier blend, or a combination thereof. For example, in any aspect or embodiment described herein, the triglyceride reaction product is present in the emulsifier blend in an amount of about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 50.0 wt %, about 30.0 wt % to about 45.0 wt %, about 30.0 wt % to about 40.0 wt %, about 35.0 wt % to about 50.0 wt %, about 35.0 wt % to about 45.0 wt %, or about 40.0 wt % to about 50.0 wt %.

By way of another example, in any aspect or embodiment described herein, the resin acid reaction product is present in the emulsifier blend in an amount of about 15.0 wt % to about 65.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 65.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 65.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 65.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 65.0 wt %, about 40.0 wt % to about 60.0 wt %, about 40.0 wt % to about 55.0 wt %, about 40.0 wt % to about 50.0 wt %, about 45.0 wt % to about 65.0 wt %, about 45.0 wt % to about 60.0 wt %, about 45.0 wt % to about 55.0 wt %, about 50.0 wt % to about 65.0 wt %, about 50.0 wt % to about 60.0 wt %, or about 55.0 wt % to about 60.0 wt %.

By way of further example, in any aspect or embodiment described herein, the additional fatty acid composition is present in the emulsifier blend in an amount of about 10.0 wt % to about 80.0 wt %, about 10.0 wt % to about 70.0 wt %, about 10.0 wt % to about 60.0 wt %, about 10.0 wt % to about 50.0 wt %, about 10.0 wt % to about 40.0 wt %, about 10.0 wt % to about 30.0 wt %, about 10.0 wt % to about 20.0 wt %, about 20.0 wt % to about 80.0 wt %, about 20.0 wt % to about 70.0 wt %, about 20.0 wt % to about 60.0 wt %, about 20.0 wt % to about 50.0 wt %, about 20.0 wt % to about 40.0 wt %, about 20.0 wt % to about 30.0 wt %, about 30.0 wt % to about 80.0 wt %, about 30.0 wt % to about 70.0 wt %, about 30.0 wt % to about 60.0 wt %, about 30.0 wt % to about 50.0 wt %, about 30.0 wt % to about 40.0 wt %, about 40.0 wt % to about 80.0 wt %, about 40.0 wt % to about 70.0 wt %, about 40.0 wt % to about 60.0 wt %, about 40.0 wt % to about 50.0 wt %, about 50.0 wt % to about 80.0 wt %, about 50.0 wt % to about 70.0 wt %, about 50.0 wt % to about 60.0 wt %, about 60.0 wt % to about 80.0 wt %, about 60.0 wt % to about 70.0 wt %, or about 70.0 wt % to about 80.0 wt %.

In any aspect or embodiment described herein, the resin acid composition present in an amount of about 5.0 wt % to about 80.0 wt % of the reaction mixture, the C₃₋₉ carboxylic-acid-bearing dienophile present in an amount of about 5.0 wt % to about 15.0 wt % of the reaction mixture, or a combination thereof. In any aspect or embodiment described herein, (i) the triglyceride composition is present in an amount of about 30.0 wt % to about 70.0 wt % of the reaction mixture; (ii) the resin acid composition present in an amount of about 40.0 wt % to about 80.0 wt % of the reaction mixture; (iii) the C₃₋₉ carboxylic-acid-bearing dienophile present in an amount of about 5.0 wt % to about 7.0 wt % of the reaction mixture; or (iv) a combination thereof.

In any aspect or embodiment described herein, the emulsifier blend comprises, consists essentially of, or consists of: (a) the combination of the triglyceride reaction product and the resin acid reaction product are present in an amount of about 50.0 wt % to about 60.0 wt %; (b) a ratio of triglyceride reaction product to resin acid reaction product is about 1:5 to about 3:2; or (c) a combination thereof.

For example, in any aspect or embodiment described herein, the combination of the triglyceride reaction product and the resin acid reaction product are present in an amount of about 50.0 wt % to about 60.0 wt %, about 50.0 wt % to about 58.0 wt %, about 50.0 wt % to about 56.0 wt %, about 50.0 wt % to about 54.0 wt %, about 50.0 wt % to about 52.0 wt %, about 52.0 wt % to about 60.0 wt %, about 52.0 wt % to about 58.0 wt %, about 52.0 wt % to about 56.0 wt %, about 52.0 wt % to about 54.0 wt %, about 54.0 wt % to about 60.0 wt %, about 54.0 wt % to about 58.0 wt %, about 54.0 wt % to about 56.0 wt %, about 56.0 wt % to about 60.0 wt %, about 56.0 wt % to about 58.0 wt %, or about 58.0 wt % to about 60.0 wt %. By way of further example, in any aspect or embodiment described herein, a ratio of triglyceride reaction product to resin acid reaction product is about 1:5 to about 3:2, about 1:5 to about 1:1, about 1:5 to about 5:6, about 1:5 to about 2:3, about 1:5 to about 1:2, about 1:5 to about 1:3, about 1:3 to about 3:2, about 1:3 to about 1:1, about 1:3 to about 5:6, about 1:3 to about 2:3, about 1:3 to about 1:2, about 1:2 to about 3:2, about 1:2 to about 1:1, about 1:2 to about 5:6, about 1:2 to about 2:3 about 2:3 to about 3:2, about 2:3 to about 1:1, about 2:3 to about 5:6, about 5:6 to about 3:2, about 5:6 to about 1:1, or about 1:1 to about 3:2.

In any aspect or embodiment described herein, reacting the triglyceride composition, the resin acid composition, and the C₃₋₉ carboxylic-acid-bearing dienophile, comprises, consists essentially of, or consists of, heating the triglyceride composition, the resin acid composition, and the C₃₋₉ carboxylic-acid-bearing dienophile reaction mixture to about 225° C. to about 245° C. (e.g., about 225° C. to about 245° C., about 225° C. to about 240° C., about 225° C. to about 235° C., about 225° C. to about 230° C., about 230° C. to about 245° C., about 230° C. to about 240° C., about 230° C. to about 235° C., about 235° C. to about 245° C., about 235° C. to about 240° C., or about 240° C. to about 245° C.) for about 2 hours to about 6 hours (e.g., about 2.5 hours to about 5.5 hours, about 3 hours to about 5 hours, about 3.5 hours to about 4.5 hours, or about 4 hours), optionally sparging the triglyceride composition, the resin acid composition, and the C₃₋₉ carboxylic-acid-bearing dienophile reaction mixture with nitrogen for the last about 0.5 hours to about 2 hours (e.g., about 0.5 hours to about 2 hours, about 0.5 hours to about 1.5 hours, about 0.5 to about 1 hours, about 1 hour to about 2 hours, about 1 hour to about 1.5 hours, about 1.5 hours to about 2 hours, or about 1 hours), thereby producing the emulsifier reaction product.

In any aspect or embodiment described herein, reacting the triglyceride composition, the resin acid composition, and the C₃₋₉ carboxylic-acid-bearing dienophile, comprises, consists essentially of, or consists of, heating the triglyceride composition, the resin acid composition, and the C₃₋₉ carboxylic-acid-bearing dienophile reaction mixture to about 225° C. to about 245° C. (e.g., about 225° C. to about 245° C., about 225° C. to about 240° C., about 225° C. to about 235° C., about 225° C. to about 230° C., about 230° C. to about 245° C., about 230° C. to about 240° C., about 230° C. to about 235° C., about 235° C. to about 245° C., about 235° C. to about 240° C., or about 240° C. to about 245° C.) for about 2 hours to about 4 hours (e.g., about 2 hours to about 4 hours, about 2 hours to about 3.5 hours, about 2 hours to about 3 hours, about 2 hours to about 2.5 hours, about 2.5 hours to about 4 hours, about 2.5 hours to about 3.5 hours, about 2.5 hours to about 3 hours, about 3 hours to about 4 hours, about 3 hours to about 3.5 hours, or about 3.5 hours to about 4 hours), and sparging the triglyceride composition, the resin acid composition, and the C₃₋₉ carboxylic-acid-bearing dienophile reaction mixture with nitrogen at a temperature of about 225° C. to about 245° C. (e.g., about 225° C. to about 245° C., about 225° C. to about 240° C., about 225° C. to about 235° C., about 225° C. to about 230° C., about 230° C. to about 245° C., about 230° C. to about 240° C., about 230° C. to about 235° C., about 235° C. to about 245° C., about 235° C. to about 240° C., or about 240° C. to about 245° C.) for up to about 3 hours (e.g., up to about 2.5 hours, up to about 2.25 hours, up to about 2 hours, about 0.5 hours to about 3 hours, about 0.5 hours to about 2.5 hours, about 0.5 hours to about 2.0 hours, about 0.5 hours to about 1.5 hours, about 0.5 hours to about 1 hour, about 1 hour to about 3 hours, about 1 hour to about 2.5 hours, about 1 hour to about 2 hours, about 1 hour to about 1.5 hours, about 1.5 hour to about 3 hours, about 1.5 hour to about 2.5 hours, about 1.5 hour to about 2 hours, about 2 hours to about 3 hours, about 2 hours to about 2.5 hours, or about 2.5 hour to about 3 hours), thereby producing the emulsifier reaction product.

In any aspect or embodiment described herein, reacting the triglyceride composition, the resin acid composition, and the C₃₋₉ carboxylic-acid-bearing dienophile, comprises, consists essentially of, or consists of, blending the emulsifier reaction product with a fatty acid composition.

In any aspect or embodiment described herein, reacting the triglyceride composition, the resin acid composition, and the C₃₋₉ carboxylic-acid-bearing dienophile, comprises, consists essentially of, or consists of, cooling the emulsifier reaction product (e.g., if blending with a fatty acid composition, cooling the reaction product to a temperature of about 60° C. to about 100° C., about 60° C. to about 90° C., about 60° C. to about 80° C., about 60° C. to about 70° C., about 70° C. to about 100° C., about 70° C. to about 90° C., about 70° C. to about 80° C., about 80° C. to about 100° C., about 80° C. to about 90° C., about 90° C. to about 100° C., or about 70° C.).

In any aspect or embodiment described herein, reacting the triglyceride composition, the resin acid composition, and the C₃₋₉ carboxylic-acid-bearing dienophile, comprises, consists essentially of, or consists of, before blending the fatty acid composition with the emulsifier reaction product, warming the emulsifier reaction product to a temperature of about 100° C. to about 130° C. (e.g., about 100° C. to about 130° C., about 100° C. to about 120° C., about 100° C. to about 110° C., about 110° C. to about 130° C., about 110° C. to about 120° C., about 115° C. to about 125° C., about 120° C. to about 130° C., or about 120° C.). In any aspect or embodiment described herein, reacting the triglyceride composition, the resin acid composition, and the C₃₋₉ carboxylic-acid-bearing dienophile, comprises, consists essentially of, or consists of, before blending the fatty acid composition with the emulsifier reaction product, warming the fatty acid composition to facilitate efficient mixing (such as, a temperature of about 70° C. to about 100° C. (e.g., about 70° C. to about 100° C., about 70° C. to about 90° C., about 70° C. to about 80° C., about 75° C. to about 100° C., about 75° C. to about 95° C., about 75° C. to about 85° C., about 80° C. to about 100° C., about 80° C. to about 90° C., about 90° C. to about 100° C., or about 80° C.).

In any aspect or embodiment described herein, the emulsifier reaction product comprises, consists essentially of, or consists of: (a) a triglyceride reaction product made by reacting the triglyceride composition and the C3-9 carboxylic-acid-bearing dienophile; (b) a resin acid reaction product made by reacting the resin acid composition and the C3-9 carboxylic-acid-bearing dienophile; and (c) a combination thereof.

In any aspect or embodiment described herein, (i) reacting a triglyceride composition and a C₃₋₉ carboxylic-acid-bearing dienophile, (ii) reacting a resin acid composition and a C₃₋₉ carboxylic-acid-bearing dienophile, or (iii) both (i) and (ii), comprises, consists essentially of, or consists of, heating the triglyceride composition and C₃₋₉ carboxylic-acid-bearing dienophile reaction mixture to about 225° C. to about 245° C. (e.g., about 225° C. to about 245° C., about 225° C. to about 240° C., about 225° C. to about 235° C., about 225° C. to about 230° C., about 230° C. to about 245° C., about 230° C. to about 240° C., about 230° C. to about 235° C., about 235° C. to about 245° C., about 235° C. to about 240° C., or about 240° C. to about 245° C.) for about 2 hours to about 6 hours (e.g., about 2 hours to about 5.5 hours, about 2 hours to about 5 hours, about 2 hours to about 4.5 hours, about 2 hours to about 4 hours, about 2 hours to about 3.5 hours, about 2 hours to about 3 hours, about 2.5 hours to about 6 hours, about 2.5 hours to about 5.5 hours, about 2.5 hours to about 5 hours, about 2.5 hours to about 4.5 hours, about 2.5 hours to about 4 hours, about 2.5 hours to about 3.5 hours, about 3 hours to about 6 hours, about 3 hours to about 5.5 hours, about 3 hours to about 5 hours, about 3 hours to about 4.5 hours, about 3 hours to about 4 hours, about 3.5 hours to about 6 hours, about 3.5 hours to about 5.5 hours, about 3.5 hours to about 5 hours, about 3.5 hours to about 4.5 hours, about 4 hours to about 6 hours, about 4 hours to about 5.5 hours, about 4 hours to about 5 hours, about 4.5 hours to about 6 hours, about 4.5 hours to about 5.5 hours, about 5 hours to about 6 hours, or about 4 hours), optionally sparging the triglyceride composition and C₃₋₉ carboxylic-acid-bearing dienophile reaction mixture with nitrogen for the last about 0.5 hours to about 2 hours (e.g., about 0.5 hours to about 2 hours, about 0.5 hours to about 1.5 hours, about 0.5 to about 1 hours, about 1 hour to about 2 hours, about 1 hour to about 1.5 hours, about 1.5 hours to about 2 hours, or about 1 hours), thereby producing the triglyceride reaction product.

In any aspect or embodiment described herein, (i) reacting a triglyceride composition and a C₃₋₉ carboxylic-acid-bearing dienophile, (ii) reacting a resin acid composition and a C₃₋₉ carboxylic-acid-bearing dienophile, or (iii) both (i) and (ii), comprises, consists essentially of, or consists of, heating the triglyceride composition and C₃₋₉ carboxylic-acid-bearing dienophile reaction mixture to about 225° C. to about 245° C. (e.g., about 225° C. to about 245° C., about 225° C. to about 240° C., about 225° C. to about 235° C., about 225° C. to about 230° C., about 230° C. to about 245° C., about 230° C. to about 240° C., about 230° C. to about 235° C., about 235° C. to about 245° C., about 235° C. to about 240° C., or about 240° C. to about 245° C.) for about 2 hours to about 4 hours (e.g., about 2 hours to about 4 hours, about 2 hours to about 3.5 hours, about 2 hours to about 3 hours, about 2 hours to about 2.5 hours, about 2.5 hours to about 4 hours, about 2.5 hours to about 3.5 hours, about 2.5 hours to about 3 hours, about 3 hours to about 4 hours, about 3 hours to about 3.5 hours, or about 3.5 hours to about 4 hours), and sparging the triglyceride composition and C₃₋₉ carboxylic-acid-bearing dienophile reaction mixture with nitrogen at a temperature of about 225° C. to about 245° C. (e.g., about 225° C. to about 245° C., about 225° C. to about 240° C., about 225° C. to about 235° C., about 225° C. to about 230° C., about 230° C. to about 245° C., about 230° C. to about 240° C., about 230° C. to about 235° C., about 235° C. to about 245° C., about 235° C. to about 240° C., or about 240° C. to about 245° C.) for up to about 3 hours (e.g., up to about 2.5 hours, up to about 2.25 hours, up to about 2 hours, about 0.5 hours to about 3 hours, about 0.5 hours to about 2.5 hours, about 0.5 hours to about 2.0 hours, about 0.5 hours to about 1.5 hours, about 0.5 hours to about 1 hour, about 1 hour to about 3 hours, about 1 hour to about 2.5 hours, about 1 hour to about 2 hours, about 1 hour to about 1.5 hours, about 1.5 hour to about 3 hours, about 1.5 hour to about 2.5 hours, about 1.5 hour to about 2 hours, about 2 hours to about 3 hours, about 2 hours to about 2.5 hours, or about 2.5 hour to about 3 hours), optionally sparging is discontinued after the heating process (e.g., at a temperature of about 185° C. to about 200° C., about 185° C. to about 195° C., about 185° C. to about 190° C., about 190° C. to about 200° C., about 190° C. to about 195° C., about 195° C. to about 200° C., or about 193° C.), thereby producing the triglyceride reaction product.

In any aspect or embodiment described herein, (i) reacting a triglyceride composition and a C₃₋₉ carboxylic-acid-bearing dienophile, (ii) reacting a resin acid composition and a C₃₋₉ carboxylic-acid-bearing dienophile, or (iii) both (i) and (ii), comprises, consists essentially of, or consists of, blending the triglyceride reaction product and the resin acid reaction product with a fatty acid composition.

In any aspect or embodiment described herein, (i) reacting a triglyceride composition and a C₃₋₉ carboxylic-acid-bearing dienophile, (ii) reacting a resin acid composition and a C₃₋₉ carboxylic-acid-bearing dienophile, or (iii) both (i) and (ii), comprises, consists essentially of, or consists of, cooling the triglyceride reaction product (e.g., if blending with a fatty acid composition, cooling the triglyceride reaction product to a temperature of about 60° C. to about 100° C., about 60° C. to about 90° C., about 60° C. to about 80° C., about 60° C. to about 70° C., about 70° C. to about 100° C., about 70° C. to about 90° C., about 70° C. to about 80° C., about 80° C. to about 100° C., about 80° C. to about 90° C., about 90° C. to about 100° C., or about 70° C.).

In any aspect or embodiment described herein, (i) reacting a triglyceride composition and a C₃₋₉ carboxylic-acid-bearing dienophile, (ii) reacting a resin acid composition and a C₃₋₉ carboxylic-acid-bearing dienophile, or (iii) both (i) and (ii), comprises, consists essentially of, or consists of, heating the resin acid composition and C₃₋₉ carboxylic-acid-bearing dienophile reaction mixture to about 195° C. to about 225° C. (e.g., about 195° C. to about 225° C., about 195° C. to about 220° C., about 195° C. to about 215° C., about 195° C. to about 210° C., about 195° C. to about 205° C., about 200° C. to about 225° C., about 200° C. to about 220° C., about 200° C. to about 215° C., about 200° C. to about 210° C., about 205° C. to about 225° C., about 205° C. to about 220° C., about 205° C. to about 215° C., about 210° C. to about 225° C., about 210° C. to about 220° C., or about 215° C. to about 225° C.) for about 0.5 hours to about 3 hours (e.g., about 0.5 hours to about 2.0 hours, about 0.5 hours to about 1.5 hours, about 0.5 hours to about 1 hour, about 1 hour to about 3 hours, about 1 hour to about 2.5 hours, about 1 hour to about 2 hours, about 1 hour to about 1.5 hours, about 1.5 hour to about 3 hours, about 1.5 hour to about 2.5 hours, about 1.5 hour to about 2 hours, about 2 hours to about 3 hours, about 2 hours to about 2.5 hours, or about 2.5 hour to about 3 hour), thereby producing the resin acid reaction product.

In any aspect or embodiment described herein, (i) reacting a triglyceride composition and a C₃₋₉ carboxylic-acid-bearing dienophile, (ii) reacting a resin acid composition and a C₃₋₉ carboxylic-acid-bearing dienophile, or (iii) both (i) and (ii), comprises, consists essentially of, or consists of, cooling the resin acid reaction product (e.g., if blending with a fatty acid composition, cooling the resin acid reaction product to a temperature of at least 120° C., about 120° C. to about 160° C., about 120° C. to about 150° C., about 120° C. to about 140° C., about 120° C. to about 130° C., about 130° C. to about 160° C., about 130° C. to about 150° C., about 130° C. to about 140° C., about 140° C. to about 160° C., about 140° C. to about 150° C., or about 150° C. to about 160° C., about 70° C. to about 90° C., about 70° C. to about 80° C., about 80° C. to about 100° C., about 80° C. to about 90° C., about 90° C. to about 100° C., or about 70° C.).

In any aspect or embodiment described herein, (i) reacting a triglyceride composition and a C₃₋₉ carboxylic-acid-bearing dienophile, (ii) reacting a resin acid composition and a C₃₋₉ carboxylic-acid-bearing dienophile, or (iii) both (i) and (ii), comprises, consists essentially of, or consists of: cooling the resin acid reaction product to a solid form (e.g., to a temperature of 100 C or below); preparing a resin acid reaction product particulate (e.g., through mechanical attrition or crushing the cooled resin acid reaction product); heating the triglyceride reaction product and optionally the fatty acid composition (e.g., heating to a temperature that facilitates the resin acid reaction product to dissolve, such as about 80° C. to about 120° C., about 80° C. to about 110° C., about 80° C. to about 100° C., about 80° C. to about 90° C., about 90° C. to about 120° C., about 90° C. to about 110° C., about 90° C. to about 100° C., about 100° C. to about 120° C., about 100° C. to about 110° C., or about 110° C. to about 120° C.); blending the resin acid reaction product particulate with the triglyceride reaction production, and optionally the fatty acid composition; or a combination thereof.

In any aspect or embodiment described herein, (i) reacting a triglyceride composition and a C₃₋₉ carboxylic-acid-bearing dienophile, (ii) reacting a resin acid composition and a C₃₋₉ carboxylic-acid-bearing dienophile, or (iii) both (i) and (ii), comprises, consists essentially of, or consists of, before blending the fatty acid composition with the triglyceride reaction product and the resin acid reaction product, warming the fatty acid composition to facilitate mixing (e.g., to a temperature of about 70° C. to about 100° C., about 70° C. to about 90° C., about 70° C. to about 80° C., about 80° C. to about 100° C., about 80° C. to about 90° C., about 90° C. to about 100° C., or about 80° C.).

In any aspect or embodiment described herein, the emulsifier composition further comprises, consists essentially of, or consists of, a fatty acid composition.

In any aspect or embodiment described herein, the fatty acid composition includes or is oleic acid, stearic acid, palmitic acid, linoleic, linolenic, a natural fatty acid mixture, crude tall oil (CTO), distilled tall oil, tall oil fatty acids (TOFA, such as Type I TOFA, Type II TOFA, Type III TOFA, or a combination thereof), vegetable oil fatty acid composition, a derivative or modified version thereof, or a mixture thereof. In any aspect or embodiment described herein, the fatty acid composition is present in an amount of up to about 70.0 wt % or about 60.0 wt % of the emulsifier composition (e.g., about 20.0 wt % to about 70.0 wt %, about 25.0 wt % to about 65.0 wt % or about 30.0 wt % to about 60.0 wt %).

In any aspect or embodiment described herein, the C₃₋₉ carboxylic-acid-bearing dienophile includes or is maleic acid, maleic anhydride, fumaric acid, itaconic acid, or a combination thereof.

### Non-Resin Acid Based Emulsifier

An additional aspect of the present disclosure provides an emulsifier composition (e.g., a non-resin acid based emulsifier) comprising, consisting essentially of, or consisting of, a blend of a fatty acid composition and a reaction product made by a process comprising, consisting essentially of, or consisting of, reacting: a triglyceride composition (e.g., a triglyceride composition present in an amount of about 80.0 wt % to about 95.0 wt % of the reaction mixture); and a C₃₋₉ carboxylic-acid-bearing dienophile (e.g., a C₃₋₉ carboxylic-acid-bearing dienophile present in an amount of about 5.0 wt % to about 20.0 wt % of the reaction mixture).

A further aspect of the present disclosure provides a method of making an emulsifier composition of the present disclosure, the method comprising, consisting essentially of, or consisting of: blending a fatty acid composition and a reaction product made by a process comprising, consisting essentially of, or consisting of, reacting: a triglyceride composition (e.g., a triglyceride composition present in an amount of about 80.0 wt % to about 95.0 wt % of the reaction mixture); and a C₃₋₉ carboxylic-acid-bearing dienophile (e.g., a C₃₋₉ carboxylic-acid-bearing dienophile present in an amount of about 5.0 wt % to about 20.0 wt % of the reaction mixture).

In any aspect or embodiment described herein, reacting a triglyceride composition and a C₃₋₉ carboxylic-acid-bearing dienophile, comprises, consists essentially of, or consists of: heating the triglyceride composition and C₃₋₉ carboxylic-acid-bearing dienophile reaction mixture to about 225° C. to about 245° C. (e.g., about 225° C. to about 245° C., about 225° C. to about 240° C., about 225° C. to about 235° C., about 225° C. to about 230° C., about 230° C. to about 245° C., about 230° C. to about 240° C., about 230° C. to about 235° C., about 235° C. to about 245° C., about 235° C. to about 240° C., or about 240° C. to about 245° C.) for about 2 hours to about 6 hours (e.g., about 2 hours to about 5.5 hours, about 2 hours to about 5 hours, about 2 hours to about 4.5 hours, about 2 hours to about 4 hours, about 2 hours to about 3.5 hours, about 2 hours to about 3 hours, about 2.5 hours to about 6 hours, about 2.5 hours to about 5.5 hours, about 2.5 hours to about 5 hours, about 2.5 hours to about 4.5 hours, about 2.5 hours to about 4 hours, about 2.5 hours to about 3.5 hours, about 3 hours to about 6 hours, about 3 hours to about 5.5 hours, about 3 hours to about 5 hours, about 3 hours to about 4.5 hours, about 3 hours to about 4 hours, about 3.5 hours to about 6 hours, about 3.5 hours to about 5.5 hours, about 3.5 hours to about 5 hours, about 3.5 hours to about 4.5 hours, about 4 hours to about 6 hours, about 4 hours to about 5.5 hours, about 4 hours to about 5 hours, about 4.5 hours to about 6 hours, about 4.5 hours to about 5.5 hours, about 5 hours to about 6 hours, or about 4 hours), optionally sparging the triglyceride composition and C₃₋₉ carboxylic-acid-bearing dienophile reaction mixture with nitrogen for the last about 0.5 hours to about 2 hours (e.g., about 0.5 hours to about 2 hours, about 0.5 hours to about 1.5 hours, about 0.5 to about 1 hours, about 1 hour to about 2 hours, about 1 hour to about 1.5 hours, about 1.5 hours to about 2 hours, or about 1 hours), thereby producing the reaction product.

In any aspect or embodiment described herein, reacting a triglyceride composition and a C₃₋₉ carboxylic-acid-bearing dienophile, comprises, consists essentially of, or consists of: heating the triglyceride composition and C₃₋₉ carboxylic-acid-bearing dienophile reaction mixture to about 225° C. to about 245° C. (e.g., about 225° C. to about 245° C., about 225° C. to about 240° C., about 225° C. to about 235° C., about 225° C. to about 230° C., about 230° C. to about 245° C., about 230° C. to about 240° C., about 230° C. to about 235° C., about 235° C. to about 245° C., about 235° C. to about 240° C., or about 240° C. to about 245° C.) for about 2 hours to about 4 hours (e.g., about 2 hours to about 4 hours, about 2 hours to about 3.5 hours, about 2 hours to about 3 hours, about 2 hours to about 2.5 hours, about 2.5 hours to about 4 hours, about 2.5 hours to about 3.5 hours, about 2.5 hours to about 3 hours, about 3 hours to about 4 hours, about 3 hours to about 3.5 hours, or about 3.5 hours to about 4 hours), and sparging the triglyceride composition and C₃₋₉ carboxylic-acid-bearing dienophile reaction mixture with nitrogen at a temperature of about 225° C. to about 245° C. (e.g., about 225° C. to about 245° C., about 225° C. to about 240° C., about 225° C. to about 235° C., about 225° C. to about 230° C., about 230° C. to about 245° C., about 230° C. to about 240° C., about 230° C. to about 235° C., about 235° C. to about 245° C., about 235° C. to about 240° C., or about 240° C. to about 245° C.) for up to about 3 hours (e.g., up to about 2.5 hours, up to about 2.25 hours, up to about 2 hours, about 0.5 hours to about 3 hours, about 0.5 hours to about 2.5 hours, about 0.5 hours to about 2.0 hours, about 0.5 hours to about 1.5 hours, about 0.5 hours to about 1 hour, about 1 hour to about 3 hours, about 1 hour to about 2.5 hours, about 1 hour to about 2 hours, about 1 hour to about 1.5 hours, about 1.5 hour to about 3 hours, about 1.5 hour to about 2.5 hours, about 1.5 hour to about 2 hours, about 2 hours to about 3 hours, about 2 hours to about 2.5 hours, or about 2.5 hour to about 3 hours), optionally sparging is discontinued after the heating process (e.g., at a temperature of about 185° C. to about 200° C., about 185° C. to about 195° C., about 185° C. to about 190° C., about 190° C. to about 200° C., about 190° C. to about 195° C., about 195° C. to about 200° C., or about 193° C.), thereby producing the reaction product.

In any aspect or embodiment described herein, reacting a triglyceride composition and a C₃₋₉ carboxylic-acid-bearing dienophile, comprises, consists essentially of, or consists of: blending the fatty acid composition and the reaction product.

In any aspect or embodiment described herein, reacting a triglyceride composition and a C₃₋₉ carboxylic-acid-bearing dienophile, comprises, consists essentially of, or consists of: prior to blending the fatty acid composition and the reaction product, cooling the reaction product (e.g., cooling the reaction product to a temperature of about 60° C. to about 100° C., about 60° C. to about 90° C., about 60° C. to about 80° C., about 60° C. to about 70° C., about 70° C. to about 100° C., about 70° C. to about 90° C., about 70° C. to about 80° C., about 80° C. to about 100° C., about 80° C. to about 90° C., about 90° C. to about 100° C., or about 70° C.).

In any aspect or embodiment described herein, reacting a triglyceride composition and a C₃₋₉ carboxylic-acid-bearing dienophile, comprises, consists essentially of, or consists of: before blending the fatty acid composition and the reaction product, warming the fatty acid composition to facilitate mixing (e.g., to a temperature of about 70° C. to about 100° C., about 70° C. to about 90° C., about 70° C. to about 80° C., about 75° C. to about 100° C., about 75° C. to about 95° C., about 75° C. to about 85° C., about 80° C. to about 100° C., about 80° C. to about 90° C., about 90° C. to about 100° C., or about 80° C.).

In any aspect or embodiment described herein, the fatty acid composition includes or is oleic acid, stearic acid, palmitic acid, linoleic, linolenic, a natural fatty acid mixture, crude tall oil (CTO), distilled tall oil, tall oil fatty acids (TOFA, such as Type I TOFA, Type II TOFA, Type III TOFA, or a combination thereof), vegetable oil fatty acid composition, a derivative or modified version thereof, or a mixture thereof. In any aspect or embodiment described herein, the fatty acid composition is present in an amount of up to about 60.0 wt % (e.g., about 20.0 wt % to about 70.0 wt %, about 25.0 wt % to about 65.0 wt % or about 30.0 wt % to about 60.0 wt %) of the emulsifier composition. In any aspect or embodiment described herein, the triglyceride composition present in an amount of about 85.0 wt % to about 95.0 wt % of the reaction mixture. In any aspect or embodiment described herein, the C₃₋₉ carboxylic-acid-bearing dienophile present in an amount of about 5.0 wt % to about 15.0 wt % of the reaction mixture.

In any aspect or embodiment describe herein, the triglyceride composition present in an amount of about 80.0 wt % to about 95.0 wt % of the reaction mixture, the C₃₋₉ carboxylic-acid-bearing dienophile present in an amount of about 5.0 wt % to about 20.0 wt % of the reaction mixture, or a combination thereof. For example, in any aspect or embodiment described herein, the triglyceride composition present in an amount of about 80.0 wt % to about 95.0 wt %, about 80.0 wt % to about 90.0 wt %, about 80.0 wt % to about 85.0 wt %, about 85.0 wt % to about 95.0 wt %, about 85.0 wt % to about 90.0 wt %, about 90.0 wt % to about 95.0 wt % of the reaction mixture. Furthermore, in any aspect or embodiment described herein, the C₃₋₉ carboxylic-acid-bearing dienophile present in an amount of about 5.0 wt % to about 20.0 wt %, about 5.0 wt % to about 15.0 wt %, about 5.0 wt % to about 10.0 wt %, about 10.0 wt % to about 20.0 wt %, about 10.0 wt % to about 15.0 wt %, or about 15.0 wt % to about 20.0 wt % of the reaction mixture.

In any aspect or embodiment described herein, (i) the triglyceride composition present in an amount of about 93.0 wt % to about 95.0 wt % of the reaction mixture; (ii) the C₃₋₉ carboxylic-acid-bearing dienophile present in an amount of about 5.0 wt % to about 7.0 wt % of the reaction mixture; or (iii) a combination thereof.

In any aspect or embodiment described herein, the C₃₋₉ carboxylic-acid-bearing dienophile includes or is maleic acid, maleic anhydride, fumaric acid, itaconic acid, or a combination thereof.

### Fatty Acid Composition and Resin Acid Composition

In any aspect or embodiment described herein, the fatty acid composition is present in an amount of up to about 70.0 wt % or about 60.0 wt % (e.g., about 20.0 wt % to about 70.0 wt %, about 25.0 wt % to about 65.0 wt %, or about 30.0 wt % to about 60.0 wt %) of the emulsifier composition. For example, in any aspect or embodiment described herein, the fatty acid composition is present in an amount of up to about 70.0 wt %, about 65.0 wt %, about 60.0 wt %, about 55.0 wt %, about 50.0 wt %, about 45.0 wt %, about 40.0 wt %, about 35.0 wt %, about 30.0 wt %, about 25.0 wt %, about 20.0 wt %, about 15.0 wt %. By way of further example, in any aspect or embodiment, the fatty acid composition is present in an amount of about 10.0 wt % to about 70.0 wt %, about 10.0 wt % to about 65.0 wt %, about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 20.0 wt % to about 70.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 30.0 wt % to about 70.0 wt %, about 30.0 wt % to about 65.0 wt %, about 30.0 wt % to about 60.0 wt %, about 30.0 wt % to about 55.0 wt %, about 30.0 wt % to about 50.0 wt %, about 40.0 wt % to about 70.0 wt %, about 40.0 wt % to about 65.0 wt %, about 40.0 wt % to about 60.0 wt %, or about 50.0 wt % to about 70.0 wt %.

In any aspect or embodiment described herein, the fatty acid composition includes or is oleic acid, stearic acid, palmitic acid, linoleic, linolenic, a natural fatty acid mixture, crude tall oil (CTO), distilled tall oil (DTO), tall oil fatty acids (TOFA, such as Type I TOFA, Type II TOFA, Type III TOFA, or a combination thereof), vegetable oil fatty acid composition, a derivative or modified version thereof, or a mixture thereof.

In any aspect or embodiment described herein, the vegetable oil fatty acid composition includes, is, or is derived from, soybean oil, olive oil, corn oil, coconut oil, tallow oil, canola oil, sesame oil, rice bran oil, almond oil, rapeseed oil, safflower oil, grapeseed oil, thistle oil, cottonseed oil, hemp oil, sunflower oil, wheat germ oil, pumpkin seed oil, peanut oil, or a mixture thereof. In any aspect or embodiment described herein, the vegetable oil fatty acid composition includes or is soybean oil or derivative thereof, olive oil or derivative thereof, corn oil or derivative thereof, coconut oil or derivative thereof, tallow oil or derivative thereof, canola oil or derivative thereof, sesame oil or derivative thereof, rice bran oil or derivative thereof, almond oil or derivative thereof, rapeseed oil or derivative thereof, safflower oil or derivative thereof, grapeseed oil or derivative thereof, thistle oil or derivative thereof, cottonseed oil or derivative thereof, hemp oil or derivative thereof, sunflower oil or derivative thereof, wheat germ oil or derivative thereof, pumpkin seed oil or derivative thereof, peanut oil or derivative thereof, or a mixture thereof.

In any aspect or embodiment described herein, the fatty acid composition is a modified fatty acid. In any aspect or embodiment described herein, the fatty acid composition a fatty acid composition that has undergone hydrolyzation, oxidation, polymerization, hydrogenation, isomerization, conjugation, a reaction with a dienophile, or a combination thereof. For example, in any aspect or embodiment described herein, the fatty acid composition is a hydrolyzed fatty acid composition, an oxidized fatty acid composition, a polymerized fatty acid composition, a hydrogenated fatty acid composition, an isomerized fatty acid composition, a conjugated fatty acid composition, a fatty acid composition that has been reacted with a dienophile, or a combination thereof.

In any aspect or embodiment described herein, the fatty acid composition is canola oil or hydrolyzed canola oil. In any aspect or embodiment described herein, the fatty acid composition is a distillate of canola oil or hydrolyzed canola oil. In any aspect or embodiment described herein, the fatty acid composition comprises, consists essentially of, or consists of, about 65.0% to about 75.0% (e.g., about 68.0% to about 72.0% or about 70.0%) oleic acid, about 15.0% to about 20.0% linoleic acid, up to about 8.0% (e.g., up to about 5.0%) palmitic acid, and up to about 8.0% (e.g., up to about 5.0%) stearic acid.

In any aspect or embodiment described herein, the resin acid composition comprises, consists essentially of, or consists of, one or more carboxylic acids, wherein each carboxylic acid has (i) three fused rings, (ii) one acid group, (iii) the formula C₁₉H₂₉COOH, C₂₀H₂₈O₂, or C₂₀H₃₀O₂, or (iv) a combination thereof. For example, in any aspect or embodiment described herein, the resin acid composition comprises, consists essentially of, or consists of, one or more C₁₉₋₂₀ tricyclic terpenoids (e.g., one or more tricyclic terpenoid, each independently having the formula C₁₉H₂₉COOH, C₂₀H₂₈O₂, or C₂₀H₃₀O₂).

In any aspect or embodiment described herein, the resin acid composition includes or is palustric acid, abietic acid, neoabietic acid, pimaric acid, isopimaric acid, dehydroabietic acid, rosin, tall oil rosin (TOR), gum rosin, wood rosin, or a combination thereof.

Tall Oil Fatty Acids (TOFA) is produced as a byproduct of the Kraft pulping process of coniferous trees. In particular, the kraft pulping process is utilized to convert wood into wood pulp, wherein crude tall oil (CTO) is produced as a byproduct. Crude tall oil can be upgraded through distillation to produce rosin-rich distillates and distilled tall oil. Distillation streams produce tall oil pitch (TOP), tall oil rosin (TOR), head streams (light ends), tall oil fatty acids (TOFA), and distilled tall oil (DTO). Pine tree-derived TOR contains several C20 acid isomers including abietic, dehydroabietic, and pimaric acids. TOFA comprises primarily C18 linear saturated and unsaturated chains (for example, linoleic acid, oleic acid, and linolenic acid). The principle composition and yields of tall oil fractions and some empirical volatility data is provided in Table 1, and exemplary data and composition of some crude tall oil is provided in Table 2, some tall oil fatty acids are provided in Table 3, and some rosin in Table 4.

TABLE 1
Composition and Yields of Tall Oil Fractions
and Empirical Volatility Data*

| | | | Composition (%) | | |
|---|---|---|---|---|---|
| | Yield | Acid | Rosin/Resin | Fatty | |
| | (%) | Number | Acids | Acids | Neutrals |
| Head, light ends | 5-12 | 70-120 | <0.5 | 30-50 | 40-60 |
| Tall Oil Fatty Acids | 35-45 | 192-197 | <2 | 95-98 | 1-2 |
| Distilled Tall Oil | 5-15 | 180-190 | 20-30 | 65-70 | 4-7 |
| Tall Oil Rosin | 20-35 | 165-182 | 85-96 | 1-5 | 1-7 |
| Tall Oil Pitch | 20-40 | 20-50 | 5-13 | 5-10 | 40-60 |

*Adapted from Table 6 of Norlin, H., et al., Ullmann's Encyclopedia of Industrial Chemistry. Volume 35, pages 583-596 (Tall Oil). 7^{th} Edition. 2012.

TABLE 2
Exemplary Data and Composition of Crude Tall Oil*

| | | United | | |
|---|---|---|---|---|
| | Scandinavia | States | Canada | |
| | (typical mix) | (pine) | (mixed) | France |
| Acid Number | 145 | 165 | 140 | 165 |
| Saponification Number | 160 | 172 | 165 | 172 |
| Fatty Acids (%) | 45 | 45 | 42 | 40 |
| Palmitic (16:0) | 1.5 | 3 | 2 | 2 |
| Stearic (18:0) | 0.5 | 1 | 1 | 1 |
| Oleic (18:1) | 10 | 20 | 10 | 15 |
| Linoleic (18:2) | 17 | 13 | 15 | 11 |
| Pinolenic (18:3) | 5 | 1 | 3 | 1 |
| Arachidic (20:0) | 1 | 0.5 | 1 | 0.5 |
| Other | 10 | 6.5 | 10 | 9.5 |
| Rosin/Resin Acids (%) | 30 | 42 | 30 | 50 |
| Pimaric | 2 | 3 | 2 | 5 |
| Palustric | 4 | 7 | 5 | 7 |
| Isopimaric | 2 | 4 | 4 | 4 |
| Abietic | 12 | 15 | 10 | 18 |
| Dehydroabietic | 5 | 4 | 4 | 5 |
| Neoabietic | 4 | 6 | 3 | 6 |
| Others | 1 | 3 | 2 | 5 |
| Neutrals (%) | 25 | 13 | 28 | 10 |

| | |
|---|---|
| Moisture | <2% |
| Ash | <0.2% |
| Mineral Acid (H₂SO₄) | <0.02% |
| Sulfur | <0.03% |

*Adapted from Table 3 of Norlin, H., et al., Ullmann's Encyclopedia of Industrial Chemistry. Volume 35, pages 583-596 (Tall Oil). 7^{th} Edition. 2012.

TABLE 3
Exemplary Data and Composition of Tall Oil Fatty Acids*

| | Scandinavia | United States |
|---|---|---|
| Acid Number | 195 | 197 |
| Rosin/Resin Acid (%) | 2 | 1 |
| Unsaponifiables (%) | 2 | 1.5 |
| Iodine Value | 150 | 130 |
| Color, Garner | 4 | 3 |
| Fatty Acids (%) | | |
| Saturated | 2 | 2 |
| Oleic (18:1) | 30 | 48 |
| Linoleic (18:2) | 44 | 37 |
| Linolenic (18:3) | 10 | 3 |
| Conjugated (18:2) | 6 | 6 |
| Other | 4 | 2.5 |

*Adapted from Table 7 of Norlin, H., et al., Ullmann's Encyclopedia of Industrial Chemistry. Volume 35, pages 583-596 (Tall Oil). 7^{th} Edition. 2012.

TABLE 4
Exemplary Data and Composition of Crude Tall Oil*

| | | | Tall Oil Rosin | | |
|---|---|---|---|---|---|
| | Rum | Wood | United | Scandinavia | |
| | Rosin | Rosin | States | I | II |
| Acid Number | 167 | 157 | 174 | 173 | 180 |
| Rosin/Resin acids (%) | 90 | 85 | 92 | 90 | 95 |
| Fatty Acids (%) | | | 2 | 4 | 2 |
| Softening point (° C.) | 78 | 73 | 75 | 66 | 75 |
| Color, USDA** | | | WW | X | XA |
| Composition of Rosin/Resin | | | | | |
| Acid Fraction (%) | | | | | |
| Pimaric | 7 | 7 | 2 | 3 | 3 |
| Palustric | 20 | 8 | 7 | 8 | 7 |
| Isopimaric | 15 | 15 | 8 | 6 | 6 |
| Abietic | 30 | 50 | 40 | 40 | 40 |
| Dehydroabietic | 5 | 8 | 20 | 22 | 23 |
| Neoabietic | 15 | 5 | 3 | 4 | 4 |

*Adapted from Table 8 of Norlin, H., et al., Ullmann's Encyclopedia of Industrial Chemistry. Volume 35, pages 583-596 (Tall Oil). 7^{th} Edition. 2012.
**For a definition of USDA color shaves, see Resins, Natural, Section 5.4.

Tall oil fatty acids (TOFA) is further broken down into Type I (minimum of 98% fatty acids and a maximum of 1% rosin/resin acids), Type II (minimum of 96% fatty acids and a maximum of 2% rosin/resin acids), and Type III (minimum of 90% fatty acids and a maximum of 10% rosin/resin acids), as shown in Table 5, depending upon acid value, rosin/resin acids concentration, unsaponifiables concentration, fatty acids concentration, Gardner color, and iodine value.

TABLE 5
Tall Oil Fatty Acids Requirements*

| | | Type I | | Type II | | Type III | |
|---|---|---|---|---|---|---|---|
| | Method | Min | Max | Min | Max | Min | Max |
| Acid Value | ASTM D1980 | 197 | — | 192 | — | 190 | — |
| Rosin/Resin Acids (%) | ASTM D1240 | — | 1.0 | — | 2.0 | — | 10.0 |
| Unsaponifiables (%) | ASTM D1965 | — | 1.0 | — | 2.0 | — | 10.0 |
| Fatty Acids (%) | ASTM D1983 | 98 | — | 96 | — | 90 | — |
| Color, Gardner | ASTM D1544 | — | 4 | — | 5 | — | 10.0 |
| Iodine Value | ASTM D1959 | 125 | 135 | — | — | — | — |

*Adapted from Table 1 of American Society for Testing and Materials (ASTM): D1984-69 (Standard Specification for Tall Oil Fatty Acids).

The standard methods recited in Table 4 can be utilized to determine the acid number, rosin/resin acid concentration (%), unsaponifiables concentration (%), fatty acids concentration (%), Gardner color, and iodine value of fatty acid compositions.

The fatty acid composition of sixteen exemplary vegetable oils, determined by gas chromatography, is shown in Table 6.

TABLE 6
Exemplary Data and Composition of Sixteen Exemplary Vegetable Oils*^{†}

| FAs [%] | SAF | GRP | SIL | HMP | SFL | WHG | PMS | SES | RB | ALM | RPS | PNT | OL | COC | TA | CO |
|---|---|---|---|---|---|---|---|---|---|---|---|---|---|---|---|---|
| C6:0 | ND | ND | ND | ND | ND | ND | ND | ND | ND | ND | ND | ND | ND | 0.52 | ND | ND |
| C8:0 | ND | 0.01 | ND | ND | ND | ND | ND | ND | ND | ND | ND | ND | ND | 7.6 | ND | ND |
| C10:0 | ND | ND | ND | ND | ND | ND | ND | ND | ND | ND | 0.01 | ND | ND | 5.5 | ND | ND |
| C12:0 | ND | 0.01 | 0.01 | ND | 0.02 | 0.07 | ND | ND | ND | 0.09 | ND | ND | ND | 47.7 | 0 | 0 |
| C14:0 | 0.10 | 0.05 | 0.09 | 0.07 | 0.09 | ND | 0.17 | ND | 0.39 | 0.07 | ND | 0.04 | ND | 19.9 | 4 | 1 |
| C15:0 | ND | 0.01 | 0.02 | ND | ND | 0.04 | ND | ND | ND | ND | 0.02 | ND | ND | ND | ND | ND |
| C16:0 | 6.7 | 6.6 | 7.9 | 6.4 | 6.2 | 17.4 | 13.1 | 9.7 | 20.0 | 6.8 | 4.6 | 7.5 | 16.5 | ND | 28 | 3 |
| C17:0 | 0.04 | 0.06 | 0.06 | 0.05 | 0.02 | 0.03 | 0.13 | ND | ND | 0.05 | 0.04 | 0.07 | ND | ND | ND | ND |
| C18:0 | 2.4 | 3.5 | 4.5 | 2.6 | 2.8 | 0.7 | 5.7 | 6.5 | 2.1 | 2.3 | 1.7 | 2.1 | 2.3 | 2.7 | 23 | 2 |
| C20:0 | ND | 0.16 | 2.6 | ND | 0.21 | ND | 0.47 | 0.63 | ND | 0.09 | ND | 1.01 | 0.43 | ND | ND | ND |
| C22:0 | ND | ND | ND | ND | ND | ND | ND | 0.14 | ND | ND | ND | ND | 0.15 | ND | ND | ND |
| C16:1 (n-7) | 0.08 | 0.08 | 0.05 | 0.11 | 0.12 | 0.21 | 0.12 | 0.11 | 0.19 | 0.53 | 0.21 | 0.07 | 1.8 | ND | ND | ND |
| C17:1 (n-7) | ND | ND | 0.03 | ND | ND | ND | ND | ND | ND | ND | ND | ND | ND | ND | ND | ND |
| C18:1 (n-9) | ND | ND | ND | ND | ND | ND | NE | ND | ND | ND | ND | ND | ND | ND | 35 | 58 |
| C18:1cis (n-9) | 11.5 | 14.3 | 20.4 | 11.5 | 28.0 | 12.7 | 24.9 | 41.5 | 42.7 | 67.2 | 63.3 | 71.1 | 66.4 | 6.2 | ND | ND |
| C18:1trans (n-9) | ND | ND | ND | ND | ND | ND | ND | ND | ND | ND | 0.14 | ND | ND | ND | ND | ND |
| C20:1(n-9) | ND | 0.40 | 0.15 | 16.5 | 0.18 | 7.91 | 1.08 | 0.32 | 1.11 | 0.16 | 9.1 | ND | 0.30 | ND | ND | ND |
| C18:2cis (n-6) | 79.0 | 74.7 | 63.3 | 39.4 | 62.2 | 59.7 | 54.2 | 40.9 | 33.1 | 22.8 | 19.6 | 18.2 | 16.4 | 1.6 | 2 | 9 |
| C18:3 | ND | ND | ND | ND | ND | ND | ND | ND | ND | ND | ND | ND | ND | ND | 1 | 23 |
| C18:3 (n-3) | 0.15 | 0.15 | 0.88 | 0.36 | 0.16 | 1.2 | 0.12 | 0.21 | 0.45 | ND | 1.2 | ND | 1.6 | ND | ND | ND |
| C18:3 (n-6) | ND | ND | ND | 3.0 | ND | ND | ND | ND | ND | ND | ND | ND | ND | ND | ND | ND |
| SFAs | 9.3 | 10.4 | 15.1 | 9.2 | 9.4 | 18.2 | 19.6 | 16.9 | 22.5 | 9.3 | 6.3 | 10.7 | 19.4 | 92.1 | ND | ND |
| MUFAs | 11.6 | 14.8 | 20.7 | 28.1 | 28.3 | 20.9 | 26.1 | 42.0 | 44.0 | 67.9 | 72.8 | 71.1 | 68.2 | 6.2 | ND | ND |
| PUFAs | 79.1 | 74.9 | 64.2 | 62.8 | 62.4 | 61.0 | 54.3 | 41.2 | 33.6 | 22.8 | 20.9 | 18.2 | 18.0 | 1.6 | ND | ND |
| n-3 PUFAs | 0.2 | 0.2 | 0.9 | 0.4 | 0.2 | 1.2 | 0.1 | 0.2 | 0.5 | 0.0 | 1.2 | 0.0 | 1.6 | 0.0 | ND | ND |
| n-6 PUFAs | 79.0 | 74.7 | 63.3 | 62.4 | 62.2 | 59.7 | 54.2 | 40.9 | 33.1 | 22.8 | 19.6 | 18.2 | 16.4 | 1.6 | ND | ND |

*Data are expressed as percentages of total fatty acid methyl esters (FAMEs); ND means that FAs was not determined. Abbreviations of the samples mean: SFA—saturated fatty acids, MUFA—monounsaturated fatty acids, PUFA—polyunsaturated fatty acids, SAF—safflower oil, GRP—grapeseed oil, SIL—silybum marianum (thistle oil), HMP—hemp oil, SEL—sunflower oil, WHG—wheat germ oil, PMS—pumpkin seed oil, SES—sesame oil, RB—rice bran oil, ALM—almond oil, RPS—rapeseed oil, PNT—peanut oil, OL—olive oil, COC—coconut oil, TA—tallow oil, and CA— canola oil.
^{†}Adapted from Table 1 of Orsavova, J., et al., Int. J. Mol. Sci. 2015. 16: 12871-12890.

### Triglyceride Composition

In any aspect or embodiment described herein, the triglyceride composition includes or is a vegetable oil. For example, in any aspect or embodiment described herein, the vegetable oil of the triglyceride composition includes or is soybean oil, olive oil, corn oil, coconut oil, tallow oil, canola oil, sesame oil, rice bran oil, almond oil, rapeseed oil, safflower oil, grapeseed oil, thistle oil, cottonseed oil, hemp oil, sunflower oil, wheat germ oil, pumpkin seed oil, peanut oil, or a mixture thereof. In any aspect or embodiment described herein, the triglyceride composition includes or is soybean oil or derivative thereof.

### Oil-Based Drilling Fluid and Methods of Using Oil-Based Drilling Fluid

Another aspect of the present disclosure provides an oil-based drilling fluid or mud comprising an invert emulsion of a hygroscopic liquid (e.g., a brine, such as CaCl₂ brine), one or more (e.g., 1, 2, 3, 4, 5, 6, 7, 8, or more) emulsifiers, and at least one of: an oil, mineral oil, synthetic oil, or a combination thereof, wherein the one or more emulsifiers includes one or more of the emulsifier compositions of the present disclosure, one or more of the emulsifier compositions produced according to the method or process of the present disclosure, or a combination thereof. In any aspect or embodiment described herein, the synthetic oil includes or is internal olefin, poly alpha olefin, linear paraffin, or a combination thereof. A further aspect of the present disclosure provides an oil-based drilling fluid or mud consisting essentially of an invert emulsion of a hygroscopic liquid (e.g., a brine, such as CaCl₂ brine), one or more (e.g., 1, 2, 3, 4, 5, 6, 7, 8, or more) emulsifiers, and at least one of: an oil, mineral oil, synthetic oil, or a combination thereof, wherein the one or more emulsifiers includes one or more of the emulsifier compositions of the present disclosure, one or more of the emulsifier compositions produced according to the method or process of the present disclosure, or a combination thereof. In any aspect or embodiment described herein, the synthetic oil includes or is internal olefin, poly alpha olefin, linear paraffin, or a combination thereof. An additional aspect of the present disclosure provides an oil-based drilling fluid or mud consisting of, an invert emulsion of a hygroscopic liquid (e.g., a brine, such as CaCl₂ brine), one or more (e.g., 1, 2, 3, 4, 5, 6, 7, 8, or more) emulsifiers, and at least one of: an oil, mineral oil, synthetic oil, or a combination thereof, wherein the one or more emulsifiers includes one or more of the emulsifier compositions of the present disclosure, one or more of the emulsifier compositions produced according to the method or process of the present disclosure, or a combination thereof. In any aspect or embodiment described herein, the synthetic oil includes or is internal olefin, poly alpha olefin, linear paraffin, or a combination thereof.

In any aspect or embodiment described herein, the oil is diesel.

In any aspect or embodiment described herein, the hygroscopic liquid is CaCl₂ brine, NaCl brine, NaBr brine, CaBr₂ brine, a formate brine, potassium formate, an alcohol based hygroscopic liquid, lower polyhydric alcohols, glycerol, or polyglycerol. In any aspect or embodiment described herein, the hygroscopic liquid is CaCl₂ brine.

In any aspect or embodiment described herein, the drilling fluid or mud further comprises one or more weighting agents (e.g., barite).

In any aspect or embodiment described herein, the drilling fluid or mud further comprises one or more (e.g., 1, 2, 3, 4, 5, 6, 7, 8, or more) rheological modifier (e.g., clay, organophilic clay, bentonite clay, amine-treated clay, amine-treated bentonite clay, a polyamide, a dimer diacid, or combinations thereof).

In any aspect or embodiment described herein, the drilling fluid or mud further comprises one or more alkalinity agent (e.g., lime, CaO, or Ca(OH)₂).

In any aspect or embodiment described herein, the drilling fluid or mud further comprises one or more wetting agent (e.g., fatty imidazolines, soya lecithin, or combinations thereof).

In any aspect or embodiment described herein, the oil-based drilling fluid or mud comprises: an invert emulsion of a hygroscopic liquid (e.g., a brine, such as CaCl₂ brine), the emulsifier composition of the present disclosure, and an oil that includes diesel), mineral oil, internal olefin, or a combination thereof.

An additional aspect of the present disclosure provides a method of drilling a wellbore, the method comprising circulating the oil-based drilling fluid of the present disclosure through the wellbore when drilling.

A further aspect of the present disclosure provides a method of drilling a wellbore, the method comprising circulating the oil-based drilling fluid of the present disclosure through the wellbore when drilling the well to depth.

### EXAMPLES

### Example 1: Making the Emulsifier by Blending Reaction Products

This example relates to preparing the emulsifier of the present disclosure from a triglyceride reaction product and a resin acid reaction product. An exemplary formulation for the triglyceride reaction product is shown in Table 7.

TABLE 7
Exemplary Triglyceride Reaction Product

| | Percent (%) Charge | Amount Charged (g) |
|---|---|---|
| Soybean Oil | 80.0 | 240.12 |
| Maleic Anhydride | 20.0 | 60.04 |
| Total | 100.0 | 300.16 |

Briefly, the soybean oil and maleic anhydride were charged into a pressure reactor. The reactor was sealed and heated to 218° C. The mixture was incubated for 30 minutes at 218° C., heated to 243° C., and incubated therefor three hours. The reactor was vented and then sparged with nitrogen for an hour. The mixture was cooled to 70° C., with the sparge stopped at 193° C., to produce the exemplary triglyceride reaction product of the present disclosure.

An exemplary formulation for the resin acid reaction product is shown in Table 8.

TABLE 8
Exemplary Resin Acid Reaction Product

| | Percent (%) Charge | Amount Charged (g) |
|---|---|---|
| Rosin R-24 | 87.5 | 875.18 |
| Maleic Anhydride | 12.5 | 125.28 |
| Typical Charge | 100.0 | |
| Typical Yield | 95.0 | 951.45 |

Briefly, Rosin R-24 was added to a vessel with a nitrogen blanket and a condenser having water flowing therethrough. The rosin was heated to 180° C. and stirred at 90 rotations per minute. The nitrogen sweep was stopped and the maleic anhydride was added, avoiding clumping. The reaction mixture was heated to 205° C. and held there for 1 hour to produce the exemplary resin acid reaction product.

One-hundred grams of the exemplary emulsifiers were prepared using the weight/weight ratios in Table 9 by blending the exemplary triglyceride reaction product and the exemplary resin acid reaction products with AltaVeg™ ND 600 (hydrolyzed canola oil, which has a fatty acid composition of about 70% oleic acid, about 15-20% linoleic acid, about 5% palmitic acid, and about 5% stearic acid); Ingevity, Inc; North Charleston, South Carolina), as the optional fatty acid composition.

TABLE 9
Weight Ratios of Exemplary Emulsifier Formulations

| Exemplary | Triglyceride | Resin Acid | Alta Veg ™ |
|---|---|---|---|
| Emulsifier No. | Reaction Product | Reaction Product | ND 600 |
| 1 | 30 | 20 | 50 |
| 2 | 20 | 35 | 45 |
| 3 | 10 | 50 | 40 |
| 4 | 20 | 0 | 80 |

Briefly, AltaVeg™ ND 600 was warmed to 80° C., the exemplary triglyceride reaction product was added, and the mixture stirred for 10 minutes. The resin acid reaction product was added to the mixture, and the resultant mixture stirred until all materials were dissolved—20 to 35 minutes—thereby producing the exemplary emulsifiers.

### Example 2: Making the Emulsifier with One Reaction Product

This example relates to preparing the emulsifier of the present disclosure from a single reaction product. An exemplary formulation for the reaction product is shown in Table 10.

TABLE 10
Exemplary Reaction Product

| | | | | | | Reaction |
|---|---|---|---|---|---|---|
| | | Rosin | Soybean | Maleic | | Temperature |
| | | S | Oil | Anhydride | Total | (° C.) |
| First | Percent (%) of | 47 | 53 | | | 243 |
| Reaction | Composition | | | | | |
| Product | Percent (%) | 40 | 45 | 15 | 100 | |
| | Charge | | | | | |
| | Amount (g) | 119.85 | 135.15 | 45.00 | 300 | |
| Second | Percent (%) of | 47 | 53 | | | 243 |
| Reaction | Composition | | | | | |
| Product | Percent (%) | 44 | 49 | 7 | 100 | |
| | Charge | | | | | |
| | Amount (g) | 131.13 | 147.87 | 21.00 | 300 | |
| Third | Percent (%) of | 67 | 34 | | | 234 |
| Reaction | Composition | | | | | |
| Product | Percent (%) | 59 | 30 | 11 | 100 | |
| | Charge | | | | | |
| | Amount (g) | 177.56 | 89.45 | 33.00 | 300 | |
| Fourth | Percent (%) of | 47 | 53 | | | 225 |
| Reaction | Composition | | | | | |
| Product | Percent (%) | 44 | 49 | 7 | | |
| | Charge | | | | | |
| | Amount (g) | 131.13 | 147.87 | 21.00 | | |
| Fifth | Percent (%) of | 86 | 14 | | | 225 |
| Reaction | Composition | | | | | |
| Product | Percent (%) | 73 | 12 | 15 | 100 | |
| | Charge | | | | | |
| | Amount (g) | 219.30 | 35.70 | 45.00 | 300.00 | |
| Sixth | Percent (%) of | 86 | 14 | | | 225 |
| Reaction | Composition | | | | | |
| Product | Percent (%) | 80 | 13 | 7 | 100 | |
| | Charge | | | | | |
| | Amount (g) | 239.94 | 39.06 | 21.00 | 300.00 | |
| Seventh | Percent (%) of | 86 | 14 | | | 243 |
| Reaction | Composition | | | | | |
| Product | Percent (%) | 73 | 12 | 15 | 100 | |
| | Charge | | | | | |
| | Amount (g) | 219.30 | 35.70 | 45.00 | 300.00 | |
| Eighth | Percent (%) of | 47 | 53 | | | 225 |
| Reaction | Composition | | | | | |
| Product | Percent (%) | 40 | 45 | 15 | 100 | |
| | Charge | | | | | |
| | Amount (g) | 119.85 | 135.15 | 45.00 | 300 | |
| Ninth | Percent (%) of | 86 | 14 | | | 243 |
| Reaction | Composition | | | | | |
| Product | Percent (%) | 80 | 13 | 7 | 100 | |
| | Charge | | | | | |
| | Amount (g) | 239.94 | 39.06 | 21.00 | 300.00 | |
| Tenth | Percent (%) of | | | | | 243 |
| Reaction | Composition | | | | | |
| Product | Percent (%) | 40 | 53 | 7 | 100 | |
| | Charge | | | | | |
| | Amount (g) | 120.00 | 159.00 | 21.00 | 300.00 | |
| Eleventh | Percent (%) of | 65 | 35 | | | 230 |
| Reaction | Composition | | | | | |
| Product | Percent (%) | 58 | 31 | 11 | 100 | |
| | Charge | | | | | |
| | Amount (g) | 173.55 | 93.45 | 33.00 | 300.00 | |
| Twelfth | Percent (%) of | 57.5 | 42.5 | | | 237.5 |
| Reaction | Composition | | | | | |
| Product | Percent (%) | 52 | 39 | 9 | 100 | |
| | Charge | | | | | |
| | Amount (g) | 156.98 | 116.03 | 27.00 | 300.00 | |
| Thirteenth | Percent (%) of | 50 | 50 | | | 245 |
| Reaction | Composition | | | | | |
| Product | Percent (%) | 45 | 45 | 11 | 100 | |
| | Charge | | | | | |
| | Amount (g) | 133.50 | 133.50 | 33.00 | 300 | |
| Fourteenth | Percent (%) of | 50 | 50 | | | 230 |
| Reaction | Composition | | | | | |
| Product | Percent (%) | 45 | 45 | 11 | 100 | |
| | Charge | | | | | |
| | Amount (g) | 133.50 | 133.50 | 33.00 | 300.00 | |

Briefly, the soybean oil, Rosin S (Ingevity, Inc., North Charleston, South Carolina), and maleic anhydride were added to a pressure reactor with stirring, sealed, and heated to 218° C., where it was incubated for 30 minutes. The mixture was then heated to 225° C. to 243° C., as indicated in Table 10, and incubated for 3 hours at that temperature. The reactor was vented and the mixture sparged with nitrogen for 1 hour. The mixture was cooled to 70° C. with the sparge stopping at 193° C. Each reaction product was heated to 120° C., and then blended with AltaVeg™ D 600 (Ingevity, Inc; North Charleston, South Carolina), as the optional fatty acid composition, at the amounts shown in Table 11 until the solids were dissolved—30 to 45 minutes—to produce the exemplary emulsifiers. AltaVeg™ D 600 is a distillate obtained by distillation of AltaVeg™ ND 600 that has a similar fatty acid distribution as AltaVeg™ ND 600, but for the residual mono-glycerides and di-glycerides being removed, and reduced concentrations of palmitic and stearic acid.

TABLE 11
Weight Ratios of Exemplary Emulsifier Formulations

| | Exemplary Emulsifier No. | | | | | | | | | | | | | | | | |
|---|---|---|---|---|---|---|---|---|---|---|---|---|---|---|---|---|---|
| | 5 | 6 | 7 | 8 | 9 | 10 | 11 | 12 | 13 | 14 | 15 | 16 | 17 | 18 | 19 | 20 | 21 |
| First | 70 | 40 | | | | | | | | | | | | | | | |
| Reaction | | | | | | | | | | | | | | | | | |
| Product | | | | | | | | | | | | | | | | | |
| (g) | | | | | | | | | | | | | | | | | |
| Second | | | 70 | | | | | | | | | | | | | | |
| Reaction | | | | | | | | | | | | | | | | | |
| Product | | | | | | | | | | | | | | | | | |
| (g) | | | | | | | | | | | | | | | | | |
| Third | | | | 55 | | | | | | | | | | | | | |
| Reaction | | | | | | | | | | | | | | | | | |
| Product | | | | | | | | | | | | | | | | | |
| (g) | | | | | | | | | | | | | | | | | |
| Fourth | | | | | 70 | | | | | | | | | | | | |
| Reaction | | | | | | | | | | | | | | | | | |
| Product | | | | | | | | | | | | | | | | | |
| (g) | | | | | | | | | | | | | | | | | |
| Fifth | | | | | | 40 | | | | | | | | | | | |
| Reaction | | | | | | | | | | | | | | | | | |
| Product | | | | | | | | | | | | | | | | | |
| (g) | | | | | | | | | | | | | | | | | |
| Sixth | | | | | | | 70 | | | | | | | | | | |
| Reaction | | | | | | | | | | | | | | | | | |
| Product | | | | | | | | | | | | | | | | | |
| (g) | | | | | | | | | | | | | | | | | |
| Seventh | | | | | | | | 40 | | | | | | | | | |
| Reaction | | | | | | | | | | | | | | | | | |
| Product | | | | | | | | | | | | | | | | | |
| (g) | | | | | | | | | | | | | | | | | |
| Eighth | | | | | | | | | 70 | 40 | | | | | | | |
| Reaction | | | | | | | | | | | | | | | | | |
| Product | | | | | | | | | | | | | | | | | |
| (g) | | | | | | | | | | | | | | | | | |
| Ninth | | | | | | | | | | | 70 | | | | | | |
| Reaction | | | | | | | | | | | | | | | | | |
| Product | | | | | | | | | | | | | | | | | |
| (g) | | | | | | | | | | | | | | | | | |
| Tenth | | | | | | | | | | | | 70 | | | | | |
| Reaction | | | | | | | | | | | | | | | | | |
| Product | | | | | | | | | | | | | | | | | |
| (g) | | | | | | | | | | | | | | | | | |
| Eleventh | | | | | | | | | | | | | 60 | | | | |
| Reaction | | | | | | | | | | | | | | | | | |
| Product | | | | | | | | | | | | | | | | | |
| Twelfth | | | | | | | | | | | | | | 67.5 | | | |
| Reaction | | | | | | | | | | | | | | | | | |
| Product | | | | | | | | | | | | | | | | | |
| Thirteenth | | | | | | | | | | | | | | | 75 | 60 | |
| Reaction | | | | | | | | | | | | | | | | | |
| Product | | | | | | | | | | | | | | | | | |
| Fourteenth | | | | | | | | | | | | | | | | | 75 |
| Reaction | | | | | | | | | | | | | | | | | |
| Product | | | | | | | | | | | | | | | | | |
| Alta Veg ™ | 30 | 60 | 30 | 45 | 30 | 30 | 30 | 60 | 30 | 60 | 30 | 30 | 40 | 32.5 | 25 | 40 | 25 |
| D600 (g) | | | | | | | | | | | | | | | | | |

### Example 3: Making Oil-Based Drilling Fluid

Performance of the emulsifier composition of the present disclosure was tested in an oil-based drilling fluid formulation. The formulation details are shown in Table 12, Table 13, and Table 14. The exemplary oil-based drilling fluid was prepared by sequentially adding the ingredients listed in Tables 12-14 and mixing for the indicated period of time with a Hamilton Beach (Glen Allen, Virginia) mixer on medium. After preparing the oil-based drilling fluid, the drilling fluid was then hot rolled at 150° F. for 16 hours. The oil-based drilling fluid was then remixed on a multi-mixer on high for 5 minutes for Tables 12 and 14, and 10 minutes for Tables 13. The 350 mL oil-based drilling fluid of Table 12 had a weight of 503.3 g, with an actual mud weight of 12.0 g, an actual mud density of 1.44 g/mL, and oil/water ratio (OWR) of 0.80. The 351.2 mL oil-based drilling fluid of Table 13 had a weight of 503.3 g, with an actual mud weight of 12.0 g, an actual mud density of 1.43 g/mL, and oil/water ratio (OWR) of 0.75. The 350 mL oil-based drilling fluid of Table 14 had a weight of 503.3 g, with an actual mud weight of 12.0 g, an actual mud density of 1.44 g/mL, and oil/water ratio (OWR) of 0.75.

TABLE 12
Exemplary oil-based drilling fluid formulation
of the present disclosure

| Component (density) | Drilling Fluid | Mixing |
|---|---|---|
| Low Sulfur Diesel Oil (0.86 g/mL) | 215.4 mL | |
| | [185.3 g] | |
| Primary Emulsifier (0.99 g/mL) | 6.1 mL | 5 |
| | [6.0 g] | |
| Lime (Ca(OH)₂; 2.24 g/mL) | 1.3 mL | 10 |
| | [3.0 g] | |
| 25% CaCl₂ Brine (1.23 g/mL) | 71.8 mL | 10 |
| | [88.3 g] | |
| Organophilic Lignite (1.8 g/mL) | 2.2 mL | 10 |
| | [4.0] | |
| Organoclay (1.6 g/mL) | 2.5 mL | 10 |
| | [4.0] | |
| Barite (4.2 g/mL) | 50.6 mL | 20 |
| | [212.7 g] | |

TABLE 13
Exemplary oil-based drilling fluid formulation
of the present disclosure

| Component (density) | Drilling Fluid | Mixing |
|---|---|---|
| Low Sulfur Diesel Oil (0.86 g/mL) | 215.4 mL | |
| | [185.3 g] | |
| Primary Emulsifier (0.99 g/mL) | 6.1 mL | 5 |
| | [6.0 g] | |
| Lime (Ca(OH)₂; 2.24 g/mL) | 1.3 mL | 5 |
| | [3.0 g] | |
| 25% CaCl₂ Brine (1.23 g/mL) | 71.8 mL | 5 |
| | [88.3 g] | |
| Organophilic Lignite (1.8 g/mL) | 2.2 mL | 5 |
| | [4.0] | |
| Organoclay (1.6 g/mL) | 2.5 mL | 5 |
| | [4.0] | |
| Barite (4.2 g/mL) | 51.9 mL | 20 |
| | [212.7 g] | |

TABLE 14
High-lime exemplary oil-based drilling fluid
formulation of the present disclosure

| Component (density) | Drilling Fluid | Mixing |
|---|---|---|
| Low Sulfur Diesel Oil (0.86 g/mL) | 214.8 mL | |
| | [184.7 g] | |
| Primary Emulsifier (0.99 g/mL) | 6.1 mL | 5 |
| | [6.0 g] | |
| Lime (Ca(OH)₂; 2.24 g/mL) | 2.7 mL | 5 |
| | [6.0 g] | |
| 25% CaCl₂ Brine (1.23 g/mL) | 71.6 mL | 5 |
| | [88.1 g] | |
| Organophilic Lignite (1.8 g/mL) | 2.2 mL | 5 |
| | [4.0] | |
| Organoclay (1.6 g/mL) | 2.5 mL | 5 |
| | [4.0] | |
| Barite (4.2 g/mL) | 50.1 mL | 20 |
| | [210.5 g] | |

### Example 3: Examining the Oil-Based Drilling Fluid

The rheological properties and emulsion stability (ES) were examined according to the methods described in API Recommended Practice 13B-2, Fourth Edition, Recommended Practice for Field Testing of Oil-based Drilling Fluids. Briefly, the oil-based drilling fluid was aged for 16 hours at 300° F. under 200 pounds per square inch (psi) nitrogen (Table 15A and Table 15C) or 150 psi nitrogen (Table 15B) using a stainless-steel rolling aging cell. After aging, the fluid was remixed using a steal mixing cup and a Hamilton Beach mixer at medium mixing speed. The rheological properties of the oil-based drilling fluid were then examined using an OFITE® 900 series rotational rheometer at 120° F. Emulsion stability (ES) was measured using an OFITE® ES meter with the fluid maintained at 120° F. High Temperature High Pressure Fluid Loss (HTHP) testing was conducted at 300° F. (Tables 15A, 15B, 15E, and 15F), 325° F. (Table 15C) or 350° F. (Table 15D) with a 500 psi differential between the top and bottom pressures, with Exemplary Emulsifiers 7 and 9 in Table 15A and Exemplary Emulsifiers 17, 18, and 19 in Table 15E also having HTHP testing conducted at 350° F. with a 500 psi differential between the top and bottom pressures. Separated fluid was collected from the bottom port of the HTHP apparatus to measure fluid loss of the mud during the test.

The performance characteristics are shown in Tables 15A-15D (oil-based drilling fluids formulations accordingly Table 12), 15E (oil-based drilling fluids formulations according to Table 13), and 15F (oil-based drilling fluids formulations according to Table 14. Maleated soybean oil and EnvaMul® 600 (a maleated tall oil-based emulsifier; Ingevity, Inc; North Charleston, South Carolina) were also examined in the exemplary oil-based drilling fluids. Rheological properties and other performance factors were within typical ranges for oil-based muds.

TABLE 15A
Performance properties for exemplary oil-based drilling fluid with the formulation of Table 12 and containing the articulated emulsifiers

| | Exemplary Emulsifier No. | | | | | | | | | | | | | |
|---|---|---|---|---|---|---|---|---|---|---|---|---|---|---|
| | | Maleated | | | | | | | | | | | | |
| Performance Properties (AHR) | 4 | Soybean Oil | 5 | 6 | 7 | 8 | 9 | 10 | 11 | 12 | 13 | 14 | 15 | 16 |
| Shear Stress for 600 RPM (DR) | 29.5 | 57.5 | 41.6 | 38 | 36.2 | 42.7 | 37 | 49.6 | 42.3 | 41.3 | 45.8 | 37 | 41.3 | 37.5 |
| Shear Stress for 300 RPM (DR) | 14.5 | 34.3 | 20.8 | 19.1 | 16.7 | 21 | 18.3 | 24 | 21.8 | 19.9 | 23.4 | 18.4 | 21 | 18.7 |
| Shear Stress for 200 RPM (DR) | 8.6 | 23.0 | 12.6 | 11.7 | 11.4 | 13 | 11.7 | 14.8 | 14.5 | 12.3 | 14.6 | 11.3 | 13.9 | 11.7 |
| Shear Stress for 100 RPM (DR) | 4.9 | 15.0 | 6.4 | 6.2 | 5.3 | 6.4 | 5.8 | 7.8 | 7.9 | 6.1 | 7.8 | 5.8 | 7.3 | 5.9 |
| Shear Stress for 6 RPM (DR) | 0.9 | 6.5 | 1.1 | 1.1 | 0.8 | 0.9 | 0.7 | 1.1 | 1.8 | 0.7 | 1.6 | 0.4 | 1.3 | 1.3 |
| Shear Stress for 3 RPM (DR) | 0.7 | 6.2 | 0.9 | 1 | 0.7 | 0.7 | 0.6 | 1 | 1.6 | 0.5 | 1.6 | 0.4 | 1.2 | 1.2 |
| Plastic Viscosity (PV) (cP) | 15.0 | 23.2 | 20.8 | 18.9 | 19.5 | 21.7 | 18.7 | 25.6 | 20.5 | 21.4 | 22.4 | 18.6 | 20.3 | 18.8 |
| Yield Point (YP) (lb/100 ft²) | −0.5 | 11.1 | 0 | 0.2 | −2.8 | −0.7 | −0.4 | −1.6 | 1.3 | −1.5 | 1 | −0.2 | 0.7 | −0.1 |
| Gel Strength 10 Seconds (DR) | 0 | 7 | 1 | 1 | 1 | 0 | 0 | 0 | 2 | 0 | 2 | 0 | 2 | 1 |
| Gel Strength 10 Minutes (DR) | 1 | 9 | 3 | 3 | 2 | 4 | 4 | 8 | 6 | 2 | 7 | 4 | 6 | 3 |
| Emulsion Stability (ES) (V) | Missed | 523 | 534 | 269 | 269 | 489 | 255 | 439 | 318 | 556 | 553 | 259 | 280 | 217 |
| High Temperature High | 14.0 | 30.0 | 8 | 4 | 4.4 | 2.4 | 3 | 2.4 | 4.4 | 4.8 | 6 | 3.2 | 8 | 4 |
| Pressure Fluid Loss @ 500 psi | | | | | | | | | | | | | | |
| and 300° F. (mL) | | | | | | | | | | | | | | |
| Water (mL) | | | 0 | 0 | 0 | 0 | 0 | 0 | 0 | 0 | 0 | 0 | 0 | 0 |
| Filter Cake Thickness (inches) | | | | | | | | | | | | | | |
| High Temperature High | | | | | | 4 | | 3 | | | | | | |
| Pressure Fluid Loss @ 500 psi | | | | | | | | | | | | | | |
| and 350° F. (mL) | | | | | | | | | | | | | | |
| Water (mL) | | | | | | 0 | | 0 | | | | | | |

TABLE 15B
Performance properties at 300° F. for exemplary
oil-based drilling fluid with the formulation of
Table 12 and containing the articulated emulsifiers

| | Exemplary Emulsifier No. | | | |
|---|---|---|---|---|
| | | | | EnvaMul ® |
| Performance Properties (AHR) | 1 | 2 | 3 | 600 |
| Shear Stress for 600 RPM (DR) | 35.9 | 35.2 | 32.3 | 33.8 |
| Shear Stress for 300 RPM (DR) | 18.7 | 16.8 | 17.2 | 17.0 |
| Shear Stress for 200 RPM (DR) | 10.9 | 11.4 | 10.6 | 9.9 |
| Shear Stress for 100 RPM (DR) | 5.6 | 4.7 | 5.5 | 4.8 |
| Shear Stress for 6 RPM (DR) | 0.4 | 0.2 | 0.6 | 0.4 |
| Shear Stress for 3 RPM (DR) | 0.3 | 0.1 | 0.5 | 0.4 |
| Plastic Viscosity (PV) (cP) | 17.2 | 18.4 | 15.1 | 16.8 |
| Yield Point (YP) (lb/100 ft²) | 1.5 | −1.6 | 2.1 | 0.2 |
| Gel Strength 10 Seconds (DR) | 0 | 0 | 0 | 0 |
| Gel Strength 10 Minutes (DR) | 3 | 3 | 3 | 2 |
| Emulsion Stability (ES) (V) | 279 | 290 | 332 | 823 |
| High Temperature High Pressure | 6.0 | 5.0 | 6.0 | 6.8 |
| Fluid Loss @ 500 psi and 300° F. | | | | |
| (mL) | | | | |
| Water (mL) | 0.0 | 0.0 | 0.0 | |

TABLE 15C
Performance properties at 325° F. for exemplary
oil-based drilling fluid with the formulation of
Table 12 and containing the articulated emulsifiers

| | Exemplary Emulsifier No. | | |
|---|---|---|---|
| | | | EnvaMul ® |
| Performance Properties (AHR) | 1 | 3 | 600 |
| Shear Stress for 600 RPM (DR) | 31.5 | 25.1 | 35.6 |
| Shear Stress for 300 RPM (DR) | 15.4 | 13.7 | 17.4 |
| Shear Stress for 200 RPM (DR) | 9.2 | 8.9 | 10.1 |
| Shear Stress for 100 RPM (DR) | 4.0 | 4.4 | 5.0 |
| Shear Stress for 6 RPM (DR) | 0.3 | 0.2 | 0.5 |
| Shear Stress for 3 RPM (DR) | 0.3 | 0.1 | 0.4 |
| Plastic Viscosity (PV) (cP) | 16.1 | 11.4 | 18.2 |
| Yield Point (YP) (lb/100 ft²) | −0.7 | 2.3 | −0.8 |
| Gel Strength 10 Seconds (DR) | 0 | 0 | 0 |
| Gel Strength 10 Minutes (DR) | 2 | 0 | 4 |
| Emulsion Stability (ES) (V) | Not | 476 | 555 |
| | Measured | | |
| High Temperature High Pressure | 7.0 | 10.0 | 8.0 |
| Fluid Loss @ 500 psi and 325° F. (mL) | | | |
| Water (mL) | 0.0 | 0.0 | 0.0 |

TABLE 15D
Performance properties at 350° F. for exemplary
oil-based drilling fluid with the formulation of
Table 12 and containing the articulated emulsifiers

| | Exemplary Emulsifier No. | | |
|---|---|---|---|
| | | | EnvaMul ® |
| Performance Properties (AHR) | 1 | 3 | 600 |
| Shear Stress for 600 RPM (DR) | 25.4 | 22.3 | 20.8 |
| Shear Stress for 300 RPM (DR) | 13.6 | 11.6 | 10.7 |
| Shear Stress for 200 RPM (DR) | 8.4 | 7.6 | 5.7 |
| Shear Stress for 100 RPM (DR) | 4.0 | 3.8 | 2.3 |
| Shear Stress for 6 RPM (DR) | 0.1 | 0.0 | 0.1 |
| Shear Stress for 3 RPM (DR) | 0.1 | 0.0 | 0.0 |
| Plastic Viscosity (PV) (cP) | 11.8 | 10.7 | 10.1 |
| Yield Point (YP) (lb/100 ft²) | 1.8 | 0.9 | 0.6 |
| Gel Strength 10 Seconds (DR) | 0 | 0 | 0 |
| Gel Strength 10 Minutes (DR) | 0 | 0 | 0 |
| Emulsion Stability (ES) (V) | 201 | 289 | 123 |
| High Temperature High Pressure | 24.0 | 16.0 | 60.0 |
| Fluid Loss @ 500 psi and 350° F. (mL) | | | |
| Water (mL) | 6.0 | 0.0 | 10.0 |

TABLE 15E
Performance properties for exemplary oil-based drilling
fluid with the formulation of Table 13 (3 ppb lime)
and containing the articulated emulsifiers

| | Exemplary Emulsifier No. | | |
|---|---|---|---|
| Performance Properties (AHR) | 17 | 18 | 19 |
| Shear Stress for 600 RPM (DR) | 38.9 | 40.7 | 41.3 |
| Shear Stress for 300 RPM (DR) | 19.7 | 20.1 | 20.6 |
| Shear Stress for 200 RPM (DR) | 12.3 | 12.0 | 12.4 |
| Shear Stress for 100 RPM (DR) | 6.0 | 5.9 | 6.1 |
| Shear Stress for 6 RPM (DR) | 0.6 | 0.4 | 0.7 |
| Shear Stress for 3 RPM (DR) | 0.6 | 0.3 | 0.5 |
| Plastic Viscosity (PV) (cP) | 19.2 | 20.6 | 20.7 |
| Yield Point (YP) (lb/100 ft²) | 0.5 | −0.5 | −0.1 |
| Gel Strength 10 Seconds (DR) | 0 | 0 | 0 |
| Gel Strength 10 Minutes (DR) | 2 | 3 | 3 |
| Emulsion Stability (ES) (V) | 685 | 410 | 588 |
| High Temperature High Pressure | 4.0 | 4.0 | 7.0 |
| Fluid Loss @ 500 psi and 300° F. (mL) | | | |
| Water (mL) | 0.00 | 0.00 | 0.00 |
| Filter Cake Thickness (inches) | 6 | 10 | 6 |
| High Temperature High Pressure | 9 | 12 | 11 |
| Fluid Loss @ 500 psi and 350° F. (mL) | | | |
| Water (mL) | 0 | 0 | 0 |

TABLE 15F
Performance properties for exemplary oil-based drilling fluid
with the formulation of Table 14 (6 ppb (high) lime formulations)
and containing the articulated emulsifiers

| | Exemplary Emulsifier No. | | | | |
|---|---|---|---|---|---|
| | | EnvaMul ® | | | |
| Performance Properties (AHR) | 1 | 600 | 17 | 20 | 21 |
| Shear Stress for 600 RPM (DR) | 38.6 | 40.1 | 42.1 | 50.4 | 44.5 |
| Shear Stress for 300 RPM (DR) | 18.2 | 20.0 | 22.5 | 25.1 | 23.2 |
| Shear Stress for 200 RPM (DR) | 11.8 | 12.3 | 15.3 | 16.5 | 14.9 |
| Shear Stress for 100 RPM (DR) | 6.4 | 6.1 | 7.9 | 8.6 | 8.0 |
| Shear Stress for 6 RPM (DR) | 0.0 | 0.7 | 0.5 | 0.7 | 0.3 |
| Shear Stress for 3 RPM (DR) | 0.0 | 0.6 | 0.4 | 0.6 | 0.2 |
| Plastic Viscosity (PV) (cP) | 20.4 | 20.1 | 19.6 | 25.3 | 21.3 |
| Yield Point (YP) (lb/100 ft²) | −2.2 | −0.1 | 2.9 | −0.2 | 1.9 |
| Gel Strength 10 Seconds (DR) | 0 | 0 | 0 | 0 | 0 |
| Gel Strength 10 Minutes (DR) | 3 | 3 | 3 | 3 | 3 |
| Emulsion Stability (ES) (V) | 271 | 806 | 408 | 522 | 598 |
| High Temperature High Pressure | 4.0 | 6.0 | 6.2 | 6.0 | 8.0 |
| Fluid Loss @ 500 psi and 300° F. | | | | | |
| (mL) | | | | | |
| Water (mL) | 0.0 | 0.0 | 0.0 | 0.0 | 0.0 |
| Filter Cake Thickness (inches) | | | 24 | 10 | |

It was surprising and unexpectedly discovered that the exemplary emulsifiers of the present disclosure produced stable emulsions, as demonstrated through fluid loss control in high-temperature, high, pressure fluid loss tests using stressed fluid systems at higher temperature (350° F.), as compared to current commercially available emulsifiers (e.g., oxidized fatty acids).

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references or publication are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range. “Combinations” is inclusive of blends, mixtures, alloys, reaction products, and the like. The terms “first”, “second”, and the like, do not denote any order, quantity, or importance, but rather are used to denote one element from another.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. An emulsifier composition comprising, consisting essentially of, or consisting of:
(a) an emulsifier reaction product made by a process comprising, consisting essentially of, or consisting of, reacting:
a triglyceride composition;
a resin acid composition; and
a C₃₋₉ carboxylic-acid-bearing dienophile; or
(b) an emulsifier blend comprising, consisting essentially of, or consisting of:
a triglyceride reaction product made by a process comprising, consisting essentially of, or consisting of, reacting a triglyceride composition and a C₃₋₉ carboxylic-acid-bearing dienophile; and
a resin acid reaction product made by a process comprising, consisting essentially of, or consisting of, reacting a resin acid composition and a C₃₋₉ carboxylic-acid-bearing dienophile.

2. The emulsifier of claim 1, wherein:
the triglyceride composition is present in an amount of about 5.0 wt % to about 80.0 wt % of the reaction mixture;
the resin acid composition present in an amount of about 5.0 wt % to about 80.0 wt % of the reaction mixture;
the C₃₋₉ carboxylic-acid-bearing dienophile present in an amount of about 5.0 wt % to about 15.0 wt % of the reaction mixture; or
a combination thereof.

3. The emulsifier of claim 1, wherein reacting the triglyceride composition, the resin acid composition, and the C₃₋₉ carboxylic-acid-bearing dienophile, comprises, consists essentially of, or consists of:
heating the triglyceride composition, the resin acid composition, and the C₃₋₉ carboxylic-acid-bearing dienophile reaction mixture to about 225° C. to about 245° C. for about 2 hours to about 6 hours, optionally sparging the triglyceride composition, the resin acid composition, and the C₃₋₉ carboxylic-acid-bearing dienophile reaction mixture with nitrogen for the last about 0.5 hours to about 2 hours, thereby producing the emulsifier reaction product;
heating the triglyceride composition, the resin acid composition, and the C₃₋₉ carboxylic-acid-bearing dienophile reaction mixture to about 225° C. to about 245° C. for about 2 hours to about 4 hours, and sparging the triglyceride composition, the resin acid composition, and the C₃₋₉ carboxylic-acid-bearing dienophile reaction mixture with nitrogen at a temperature of about 225° C. to about 245° C. for up to about 3 hours, thereby producing the emulsifier reaction product;
optionally, blending the emulsifier reaction product with a fatty acid composition;
cooling the emulsifier reaction product;
before blending the fatty acid composition with the emulsifier reaction product, warming the emulsifier reaction product to a temperature of about 100° C. to about 130° C.;
before blending the fatty acid composition with the emulsifier reaction product, warming the fatty acid composition to facilitate mixing; or
a combination thereof.

4. The emulsifier of claim 1, wherein:
the reaction mixture of the triglyceride reaction product comprises, consists essentially of, or consists of, the triglyceride composition in an amount of about 78.0 wt % to about 94.0 wt %, the C₃₋₉ carboxylic-acid-bearing dienophile in an amount of about 6.0 wt % to about 22.0 wt % %, or a combination thereof;
the reaction mixture of the resin acid reaction product comprises, consists essentially of, or consists of, the resin acid composition in an amount of about 86.0 wt % to about 92.0 wt %, the C₃₋₉ carboxylic-acid-bearing dienophile in an amount of about 8.0 wt % to about 14.0 wt %, or a combination thereof;
the triglyceride reaction product is present in an amount of about 5.0 wt % to about 50.0 wt % of the emulsifier blend, the resin acid reaction product is present in an amount of about 15.0 wt % to about 65.0 wt % of the emulsifier blend, an additional fatty acid composition is present in an amount of about 10 wt % to about 80.0 wt % of the emulsifier blend, or a combination thereof; or
a combination thereof.

5. The emulsifier of claim 1, wherein the emulsifier blend comprises, consists essentially of, or consists of:
the combination of the triglyceride reaction product and the resin acid reaction product are present in an amount of about 50.0 wt % to about 60.0 wt %;
a ratio of triglyceride reaction product to resin acid reaction product is about 1:5 to about 3:2; or
a combination thereof.

6. The emulsifier of claim 1, wherein (i) reacting a triglyceride composition and a C₃₋₉ carboxylic-acid-bearing dienophile, (ii) reacting a resin acid composition and a C₃₋₉ carboxylic-acid-bearing dienophile, or (iii) both (i) and (ii), comprises, consists essentially of, or consists of:
heating the triglyceride composition and C₃₋₉ carboxylic-acid-bearing dienophile reaction mixture to about 225° C. to about 245° C. for about 2 hours to about 6 hours, optionally sparging the triglyceride composition and C₃₋₉ carboxylic-acid-bearing dienophile reaction mixture with nitrogen for the last about 0.5 hours to about 2 hours, thereby producing the triglyceride reaction product;
heating the triglyceride composition and C₃₋₉ carboxylic-acid-bearing dienophile reaction mixture to about 225° C. to about 245° C. for about 2 hours to about 4 hours, and sparging the triglyceride composition and C₃₋₉ carboxylic-acid-bearing dienophile reaction mixture with nitrogen at a temperature of about 225° C. to about 245° C. for up to about 3 hours, optionally sparging is discontinued after the heating process, thereby producing the triglyceride reaction product;
optionally, blending the triglyceride reaction product and the resin acid reaction product with a fatty acid composition;
cooling the triglyceride reaction product;
heating the resin acid composition and C₃₋₉ carboxylic-acid-bearing dienophile reaction mixture to about 195° C. to about 225° C. for about 0.5 hours to about 3 hours, thereby producing the resin acid reaction product;
cooling the resin acid reaction product;
before blending the fatty acid composition with the triglyceride reaction product and the resin acid reaction product, warming the fatty acid composition to facilitate mixing; or
a combination thereof.

7. The emulsifier of claim 1, wherein the emulsifier composition further comprises, consists essentially of, or consists of, a fatty acid composition.

8. The emulsifier of claim 3, wherein:
the fatty acid composition includes or is oleic acid, stearic acid, palmitic acid, linoleic, linolenic, a natural fatty acid mixture, crude tall oil (CTO), distilled tall oil, tall oil fatty acids (TOFA), vegetable oil fatty acid composition, a derivative or modified version thereof, or a mixture thereof;
the fatty acid composition is present in an amount of up to about 70.0 wt % or about 60.0 wt % of the emulsifier composition; or
a combination thereof.

9. The emulsifier of claim 1, wherein:
the resin acid composition includes or is one or more carboxylic acids, wherein each carboxylic acid has (i) three fused rings, (ii) one acid group, (iii) the formula C₁₉H₂₉COOH, C₂₀H₂₈O₂, or C₂₀H₃₀O₂, or (iv) a combination thereof;
the resin acid composition includes or is one or more C₁₉₋₂₀ tricyclic terpenoids; or
a combination thereof.

10. An emulsifier composition comprising, consisting essentially of, or consisting of, a blend of a fatty acid composition and a reaction product made by a process comprising, consisting essentially of, or consisting of, reacting:
a triglyceride composition; and
a C₃₋₉ carboxylic-acid-bearing dienophile.

11. The emulsifier of claim 10, wherein reacting a triglyceride composition and a C₃₋₉ carboxylic-acid-bearing dienophile, comprises, consists essentially of, or consists of:
heating the triglyceride composition and C₃₋₉ carboxylic-acid-bearing dienophile reaction mixture to about 225° C. to about 245° C. for about 2 hours to about 6 hours, optionally sparging the triglyceride composition and C₃₋₉ carboxylic-acid-bearing dienophile reaction mixture with nitrogen for the last about 0.5 hours to about 2 hours, thereby producing the reaction product;
heating the triglyceride composition and C₃₋₉ carboxylic-acid-bearing dienophile reaction mixture to about 225° C. to about 245° C. for about 2 hours to about 4 hours, and sparging the triglyceride composition and C₃₋₉ carboxylic-acid-bearing dienophile reaction mixture with nitrogen at a temperature of about 225° C. to about 245° C. for up to about 3 hours, optionally sparging is discontinued after the heating process, thereby producing the reaction product;
blending the fatty acid composition and the reaction product;
prior to blending the fatty acid composition and the reaction product, cooling the reaction product;
before blending the fatty acid composition and the reaction product, warming the fatty acid composition to facilitate mixing; or
a combination thereof.

12. The emulsifier of claim 10, wherein:
the fatty acid composition includes or is oleic acid, stearic acid, palmitic acid, linoleic, linolenic, a natural fatty acid mixture, crude tall oil (CTO), distilled tall oil, tall oil fatty acids (TOFA), vegetable oil fatty acid composition, a derivative or modified version thereof, or a mixture thereof;
the fatty acid composition is present in an amount of up to about 70.0 wt % or about 60.0 wt % of the emulsifier composition;
the triglyceride composition present in an amount of about 80.0 wt % to about 95.0 wt % of the reaction mixture;
the C₃₋₉ carboxylic-acid-bearing dienophile present in an amount of about 5.0 wt % to about 20.0 wt % of the reaction mixture; or
a combination thereof.

13. The emulsifier of claim 10, wherein:
the triglyceride composition present in an amount of about 93.0 wt % to about 95.0 wt % of the reaction mixture;
the C₃₋₉ carboxylic-acid-bearing dienophile present in an amount of about 5.0 wt % to about 7.0 wt % of the reaction mixture; or
a combination thereof.

14. The emulsifier of claim 11, wherein:
the triglyceride composition includes or is a vegetable oil;
the resin acid composition includes or is palustric acid, abietic acid, neoabietic acid, pimaric acid, isopimaric acid, dehydroabietic acid, rosin, tall oil rosin (TOR), gum rosin, wood rosin, or a combination thereof;
the C₃₋₉ carboxylic-acid-bearing dienophile, or an anhydride thereof, includes or is maleic acid, maleic anhydride, fumaric acid, itaconic acid, or a combination thereof; or
a combination thereof.

15. The emulsifier of claim 8, wherein:
the vegetable oil of the triglyceride composition includes or is soybean oil, olive oil, corn oil, coconut oil, tallow oil, canola oil, sesame oil, rice bran oil, almond oil, rapeseed oil, safflower oil, grapeseed oil, thistle oil, cottonseed oil, hemp oil, sunflower oil, wheat germ oil, pumpkin seed oil, peanut oil, or a mixture thereof;
the vegetable oil fatty acid composition includes, is, or is derived from, soybean oil, olive oil, corn oil, coconut oil, tallow oil, canola oil, sesame oil, rice bran oil, almond oil, rapeseed oil, safflower oil, grapeseed oil, thistle oil, cottonseed oil, hemp oil, sunflower oil, wheat germ oil, pumpkin seed oil, peanut oil, or a mixture thereof; or
a combination thereof.

16. A method of making an emulsifier composition of claim 1, the method comprising, consisting essentially of, or consisting of:
(a) reacting:
a triglyceride composition;
a resin acid composition; and
a C₃₋₉ carboxylic-acid-bearing dienophile, thereby forming an emulsifier reaction product; or
(b) blending:
a triglyceride reaction product made by a process comprising, consisting essentially of, or consisting of, reacting a triglyceride composition and a C₃₋₉ carboxylic-acid-bearing dienophile; and
a resin acid reaction product made by a process comprising, consisting essentially of, or consisting of, reacting a resin acid composition and a C₃₋₉ carboxylic-acid-bearing dienophile,
thereby forming an emulsifier blend.

17. A method of making an emulsifier composition of claim 10, the method comprising, consisting essentially of, or consisting of:
blending a fatty acid composition and a reaction product made by a process comprising, consisting essentially of, or consisting of, reacting:
a triglyceride composition; and
a C₃₋₉ carboxylic-acid-bearing dienophile.

18. An oil-based drilling fluid comprising, consisting essentially of, or consisting of, an invert emulsion of a hygroscopic liquid, one or more emulsifier, and at least one of: an oil, mineral oil, synthetic oil, or a combination thereof,
wherein the one or more emulsifiers includes the emulsifier composition of claim 1.

19. The oil-based drilling fluid of claim 18, wherein:
the oil is diesel;
the hygroscopic liquid is CaCl₂ brine, NaCl brine, NaBr brine, CaBr₂ brine, formate brine, potassium formate, an alcohol based hygroscopic liquid, lower polyhydric alcohols, glycerol, or polyglycerol; or
a combination thereof.

20. The oil-based drilling fluid of claim 18, further comprising:
one or more weighting agents;
one or more rheological modifier;
one or more alkalinity agent;
one or more wetting agent; or
a combination thereof.

21. The oil-based drilling fluid of claim 18, wherein the oil-based drilling fluid comprises an invert emulsion of a hygroscopic liquid, the emulsifier composition, and an oil that includes diesel, mineral oil, internal olefin, or a combination thereof.

22. A method of drilling a wellbore, the method comprising circulating the oil-based drilling fluid of claim 18
